(19) United States
(12) Patent Application Publication
(10) Pub. No.: US 2026/0339549 A1
(43) Pub. Date: Oct. 29, 2026

(54) DATA STORAGE APPARATUS AND OPERATION METHOD FOR AVOIDING PROGRAM OPERATION DELAY DUE TO PARITY BUFFER SIZE

(71) Applicant: SK hynix Inc., Gyeonggi-do (KR)

(72) Inventors: Hee Chan SHIN, Gyeonggi-do (KR); Eui Dong LEE, Gyeonggi-do (KR)

(21) Appl. No.: 19/337,918

(22) Filed: Sep. 24, 2025

(30) Foreign Application Priority Data
Apr. 25, 2025 (KR) 10-2025-0054437

(51) Int. Cl. G06F 3/06

(52) U.S. Cl. CPC G06F 3/0656; G06F 3/0613; G06F 3/0673

(57) ABSTRACT

A memory system includes a memory device and a controller. The memory device includes a plurality of data storage areas. The controller is configured to secure an available space in a first parity buffer by migrating a first parity, corresponding to a plurality of first data, from the first parity buffer to a second parity buffer when at least one area among the plurality of data storage areas is in an idle state and a time for which the first parity is stored in the first parity buffer is greater than a reference time, to generate a second parity corresponding to a plurality of second data, and to store the second parity in the available space in the first parity buffer.

### CROSS-REFERENCE TO RELATED APPLICATIONS

This patent application claims the benefit of Korean Patent Application No. 10-2025-0054437, filed on Apr. 25, 2025, the entire disclosure of which is incorporated herein by reference.

### TECHNICAL FIELD

One or more embodiments of the present disclosure described herein relates to a data storage device or a memory system, and more particularly, to a data storage device and an operating method for avoiding a program operation delay due to a parity buffer.

### BACKGROUND

A data processing system including a memory system or a data storage device is being developed to store more data in the data storage device, store data in the data storage device more quickly, and output data stored in the data storage device more quickly. The data storage device may include non-volatile memory cells and/or volatile memory cells for storing data. Additionally, each of the memory cells may store multi-bit data. The memory system generates and stores a parity associated with multiple data stored in multiple storage areas, thereby securing data safety through the parity.

### BRIEF DESCRIPTION OF THE DRAWINGS

The description herein makes reference to the accompanying drawings wherein like reference numerals refer to like parts throughout the figures.

FIG. 1 illustrates a program operation performed in a data storage device or a memory system according to an embodiment of the present disclosure.

FIG. 2 illustrates a data processing system according to an embodiment of the present disclosure.

FIG. 3 illustrates a redundant array of independent disks (RAID).

FIG. 4 illustrates an embodiment of storing data in a unit of super memory blocks set within a memory device.

FIG. 5 illustrates an embodiment of a memory device in which multiple write data and parity data are distributed and stored in multiple locations.

FIG. 6 illustrates a case in which there is no parity migration of a memory system according to an embodiment of the present disclosure.

FIG. 7 illustrates a case in which there is parity migration of a memory system according to an embodiment of the present disclosure.

FIG. 8 illustrates a first operation of a memory system according to an embodiment of the present disclosure.

FIG. 9 illustrates a second operation of a memory system according to an embodiment of the present disclosure.

FIG. 10 illustrates a data processing system according to an embodiment of the present disclosure.

FIG. 11 illustrates a memory system according to an embodiment of the present disclosure.

### DETAILED DESCRIPTION

Various embodiments of the present disclosure are described below with reference to the accompanying drawings. Elements and features of this disclosure may be configured or arranged differently to form other embodiments, which may be variations of any of the disclosed embodiments.

In this disclosure, references to various features (e.g., elements, structures, modules, components, steps, operations, characteristics, etc.) included in “one embodiment,” “example embodiment,” “an embodiment,” “another embodiment,” “some embodiments,” “various embodiments,” “other embodiments,” “alternative embodiment,” and the like are intended to mean that any such features are included in one or more embodiments of the present disclosure, but may or may not necessarily be combined in the same embodiments.

In this disclosure, the terms “comprise,” “comprising,” “include,” and “including” are open-ended. As used in the appended claims, these terms specify the presence of the stated elements and do not preclude the presence or addition of one or more other elements. Furthermore, the terms in a claim do not foreclose the apparatus from including additional components, e.g., an interface unit, circuitry, etc.

In this disclosure, various units, circuits, or other components may be described or claimed as “configured to” perform a task or tasks. In such contexts, “configured to” is used to connote structure by indicating that the blocks/units/circuits/components include structure (e.g., circuitry) that performs one or more tasks during operation. As such, the block/unit/circuit/component can be said to be configured to perform the task even when the specified block/unit/circuit/component is not currently operational, e.g., is not turned on nor activated. The block/unit/circuit/component used with the “configured to” language include hardware, for example, circuits, memory storing program instructions executable to implement the operation, etc. Additionally, “configured to” can include a generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks.

As used in this disclosure, the term ‘circuitry’ or ‘logic’ refers to all of the following: (a) hardware-only circuit implementations (such as implementations in only analog and/or digital circuitry) and (b) combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions and (c) circuits, such as a microprocessor(s) or a portion of a microprocessor(s), that require software or firmware for operation, even if the software or firmware is not physically present. This definition of ‘circuitry’ or ‘logic’ applies to all uses of this term in this application, including in any claims. As a further example, as used in this application, the term “circuitry” or “logic” also covers an implementation of merely a processor (or multiple processors) or portion of a processor and its (or their) accompanying software and/or firmware. The term “circuitry” or “logic” also covers, for example, and if applicable to a particular claim element, an integrated circuit for a storage device.

As used herein, the terms “first,” “second,” “third,” and so on are used as labels for nouns that they precede, and do not imply any type of ordering (e.g., spatial, temporal, logical, etc.). The terms “first” and “second” do not necessarily imply that the first value must be written before the second value. Further, although the terms may be used herein to identify various elements, these elements are not limited by these terms. These terms are used to distinguish one element from another element that otherwise have the same or similar names. For example, a first circuitry may be distinguished from a second circuitry.

Further, the term “based on” is used to describe one or more factors that affect a determination. This term does not foreclose additional factors that may affect a determination. That is, a determination may be solely based on those factors or based, at least in part, on those factors. Consider the phrase “determine A based on B.” While in this case, B is a factor that affects the determination of A, such a phrase does not foreclose the determination of A from also being based on C. In other instances, A may be determined based solely on B.

Herein, a data entry, an entry of data, an item of data, or a data item may be a sequence of bits. For example, the data entry may include the contents of a file, a portion of the file, a page in memory, an object in an object-oriented program, a digital message, a digital scanned image, a part of a video or audio signal, metadata or any other entity which can be represented by a sequence of bits. According to an embodiment, the data entry may include a discrete object. According to another embodiment, the data entry may include a unit of information processed or handled for a data input/output operation. According to another embodiment, the data entry may include a unit of information within a transmission packet between two different components.

Embodiments of the present disclosure can provide a memory device, a memory system including the memory device, a controller included in the memory system, or a data processing device including the memory system.

One embodiment of the present disclosure can provide an apparatus and an operating method for improving data input/output performance in a memory system by reducing or avoiding a delay in write operations in which a controller generates at least one parity for multiple data, due to a buffer size limitation, during the write operations that stores a large amount of data in the memory system.

One embodiment of the present disclosure provides an apparatus and an operating method for reducing or avoiding a delay in program operations performed with plural areas by recognizing that at least some areas where no program operation is performed and moving or migrating a parity and associated data from a first buffer to a second buffer if the parity and the associated data are maintained or kept in the first buffer for a preset reference time or longer, thereby reducing or avoiding the delay in the program operations in the at least some areas where no program operation is performed.

In an embodiment, a memory system can include a memory device comprising a plurality of data storage areas; and a controller configured to secure an available space in a first parity buffer by migrating a first parity, corresponding to a plurality of first data, from the first parity buffer to a second parity buffer when at least one area among the plurality of data storage areas is in an idle state and a time for which the first parity is stored in the first parity buffer is greater than a reference time, to generate a second parity corresponding to a plurality of second data, and to store the second parity in the available space in the first parity buffer.

The first parity buffer can have a faster data input and output (input/output) speed than the second parity buffer.

The first parity buffer can be set or established in a static random-access memory (SRAM), and the second parity buffer can be set or established in a dynamic random-access memory (DRAM).

The controller can be configured to migrate a first parity group, comprising the first parity and the plurality of first data, from the first parity buffer to the second parity buffer.

The controller can be configured to release the first parity group from the second parity buffer based on receiving a program completion for the first parity and the plurality of first data from the memory device.

The controller can be configured to receive a plurality of data from an external device, determine the plurality of first data from the plurality of data, and map a physical address in the memory device where the plurality of first data are stored and a logical address of the plurality of first data.

In the memory device, each of the plurality of data storage areas can be configured to independently perform a read operation, a program operation, and an erase operation. While the erase operation is performed in a first storage area among the plurality of data storage areas, the program operation or the read operation can be performed in a second storage area among the plurality of data storage areas.

In the memory system, wherein each of the plurality of data storage areas comprises a memory die or a memory plane.

The controller can be configured to transfer the plurality of first data to the memory device and then transfer the first parity to the memory device. The memory system can be configured to distribute and program the plurality of first data and the first parity in different data storage areas.

The controller can be configured to: maintain the first parity in the first parity buffer and delay generation of the second parity when the plurality of data storage areas are busy; and delay the generation of the second parity when there is no available space for storing the second parity in the first parity buffer.

The controller can be configured to periodically check a time length that the first parity is stored in the first parity buffer. The reference time can be less than an operation margin of the erase operation performed in the memory device and greater than an operation margin of the program operation.

In another embodiment, a memory system can include a memory device comprising a plurality of memory planes or a plurality of memory dies configured to independently perform data input and output (input/output) operations; and a controller configured to migrate a first parity associated with a plurality of first data from a first page buffer to a second page buffer to secure an available space in the first page buffer, the first parity being remained in the first page buffer based on whether the plurality of first data are stored in the plurality of memory planes or the plurality of memory dies after transferring the plurality of first data to the plurality of memory planes or the plurality of memory dies, generate a second parity associated with a plurality of second data to be transferred and stored in the plurality of memory planes or the plurality of memory dies, and store the second parity in the available space.

The controller can be configured to migrate the first parity from the first page buffer to the second page buffer when a time for which the first parity has been stored in the first page buffer is greater than a reference time.

The first parity buffer can have a faster data input/output speed than the second parity buffer.

The controller can be configured to migrate a first parity group, comprising the first parity and the plurality of first data, from the first parity buffer to the second parity buffer.

The controller can be configured to release the first parity group from the second parity buffer based on a program completion for the first parity and the plurality of first data from the memory device.

The controller can be configured to: transmit each of the plurality of first data to the plurality of memory dies or the plurality of memory planes in a distributed manner; and transmit the first parity to a memory plane or a memory die to which the plurality of first data has not been transmitted.

The controller can be configured to: maintain the first parity in the first parity buffer and delay the generation of the second parity when all of the plurality of memory planes or the plurality of memory dies are busy; and delay the generation of the second parity when there is no available space for storing the second parity in the first parity buffer.

In another embodiment, a method for operating a memory system can include determining a plurality of first data distributed and stored in a plurality of memory planes or a plurality of memory dies; calculating a first parity associated with the plurality of first data; determining whether at least one of the plurality of memory planes or the plurality of memory dies is idle after transferring at least some of the plurality of first data to the plurality of memory planes or the plurality of memory dies; migrating the first parity from a first page buffer to a second page buffer when the at least one of the plurality of memory planes or the plurality of memory dies is idle to secure an available in the first page buffer; and generating a second parity which is stored in the available space and associated with the plurality of second data to be distributed and stored in the plurality of memory planes or the plurality of memory dies.

The method can further include transferring the first parity in the second parity buffer after the plurality of first data are stored in the plurality of memory planes or the plurality of memory dies.

The method can further include maintaining the first parity in the first parity buffer and delaying generation of the second parity when all of the plurality of memory planes or the plurality of memory dies are busy.

The method may further include delaying generation of the second parity when there is no available space to store the second parity in the first parity buffer.

An embodiment described herein can provide an apparatus and a method for improving a data input/output operation of a memory system or a data processing system. Embodiments will now be described with reference to the accompanying drawings, wherein like numbers reference like elements.

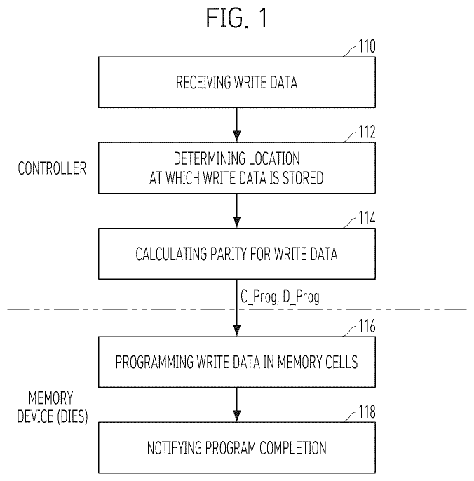

FIG. 1 illustrates a program operation performed in a data storage device or a memory system according to an embodiment of the present disclosure.

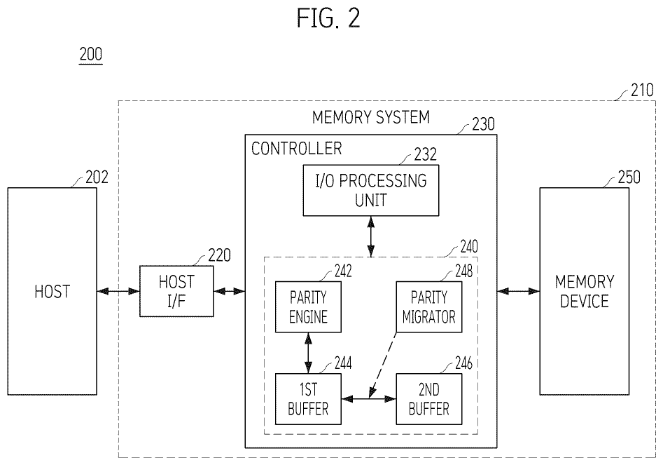

Referring to FIG. 1, the data storage device (or the memory system) can store data in an internal data storage area through a program operation. According to an embodiment, the data storage device (or the memory system) can include a controller and a memory device. Specific configurations and operations of the controller and the memory device in the data storage device (or the memory system) will be described later with reference to FIGS. 2, 10, and 11.

The controller can receive write data from an external device connected to the data storage device (operation 110). For example, the data storage device can receive a write command transmitted along with the write data from the external device.

The controller can store the write data transmitted from the external device in the memory device. To this end, the controller may determine a location in the memory device where the write data is to be stored (operation 112). According to an embodiment, the controller can link a logical address used by the external device with a physical address or a virtual address used in the data storage device. The location where the write data is to be stored in the memory device may be determined based on the configuration and operation characteristics of the memory device.

According to an embodiment, the controller may group the write data (e.g., configure a group of data to be stored in the memory device). The memory device can include a plurality of storage areas. Data input/output operations can be performed independently in the plurality of storage areas. The data storage device may perform data input/output operations in parallel to improve data input/output performance. The controller may control and process the data input/output operations for the plurality of storage areas using a plurality of pipeline structures, thereby improving a throughput of the data input/output operations.

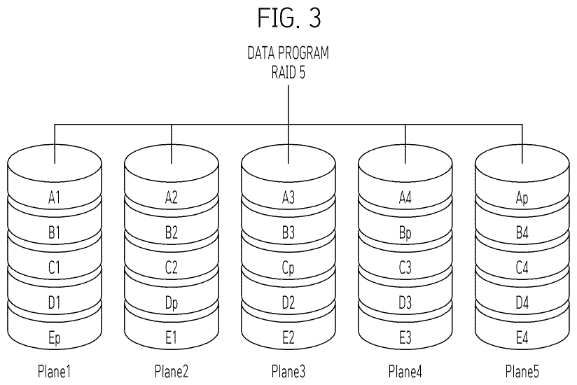

The controller can calculate a parity for (grouped) write data distributed and stored in the plurality of storage areas (operation 114). Through the parity associated with plural data stored in the plurality of storage areas, an error included in the plural data could be found or recovered (or corrected). The utilization of parity will be described later with reference to FIGS. 3 to 5.

The controller can include a calculation device for parity calculation and a buffer for storing a result of the parity calculation. In addition, the controller can store a parity group including a parity and a plurality of data in the buffer and then maintain the parity group in the buffer until the parity group is stored in the memory device. When operations for storing or transferring, in or to the memory device, at least one of the parity or the plurality of data in the parity group is delayed, another parity group (or plural other parity groups) could be accumulated in the buffer. When a size of the buffer included in the controller is not great, an operation for calculating a new parity could be delayed because plural parity groups are accumulated in the buffer. The direction of improvement of the data processing device having a size limitation of the buffer, used for a parity calculation performed by the controller, will be described later with reference to FIG. 2 and FIG. 6 to FIG. 9.

After performing the parity calculation (operation 114), the controller can transmit a program command C_Prog and program data D_Prog to the memory device. According to an embodiment, the memory device can include a plurality of storage areas or a plurality of memory dies. The plurality of storage areas or the plurality of memory dies can individually transfer or exchange commands, data, etc., to or with the controller. The controller and the plurality of storage areas or the plurality of memory dies can be coupled through at least one channel or at least one data path, etc.

According to an embodiment, the memory device can perform a program operation based on the program command C_Prog and the program data D_Prog transmitted from the controller (operation 116). When storing data in non-volatile memory cells included in the memory device, the memory device can sequentially program data in an open memory block. According to an embodiment, when storing data in volatile memory cells in the memory device, the memory device could also store data in a location designated by the controller.

The memory device can notify the controller of a program completion or a storage completion after completing the program operation within the memory device (operation 118). When the memory device includes a plurality of storage areas or a plurality of memory dies, an operation of programming or storing data can be individually performed in the plurality of storage areas or the plurality of memory dies. The plurality of storage areas or the plurality of memory dies can individually notify the controller of the program completion or the storage completion.

The controller can be configured to receive the program completion or the storage completion transmitted from the memory device and to check or recognize whether all of the plurality of data and the parity included in a specific parity group have been stored in the plurality of storage areas or the plurality of memory dies. After the plurality of data and the parity included in the corresponding parity group are stored in the memory device, the controller can release or erase the corresponding parity group stored in the buffer.

The controller can include, or operate with, a volatile memory having a fast operation speed (e.g., data input/output speed) together with at least one computational device. For example, the volatile memory included in, or linked to, the controller can include a static random-access memory (SRAM) and a dynamic random-access memory (DRAM). Here, the SRAM may operate faster than the DRAM, which is another example of the volatile memory. While the SRAM is formed as a system on chip (SoC) that is included in a single chip together with other components during a manufacturing process of the controller, the DRAM is usually formed as a separate chip that is physically distinct from the controller. According to an embodiment, the controller can access the DRAM through a separate driving device or a separate input/output interface. Therefore, in comparison with the DRAM, there may be more limitations or restrictions (e.g., technical limitations, manufacturing cost limitations, etc.) in increasing a data storage space of the SRAM. Hereinafter, in order to improve the data input/output performance of the data storage device using different types of volatile memory, an apparatus and an operating method for setting and managing a buffer used for the parity operation are described.

FIG. 2 illustrates a data processing device according to an embodiment of the present disclosure. Specifically, FIG. 2 is a block diagram illustrating a data processing device 200 in which a memory system 210 according to an embodiment of the present disclosure can serve as a data storage device of a host 202.

Referring to FIG. 2, the memory system 210 can include a memory device 250. The host 202 can utilize the memory device 250, including non-volatile memory cells, included in the memory system 210 to store data and retrieve stored data. For example, the memory device 250 can include at least one of any type of non-volatile memory such as Magneto-resistive RAM (MRAM), NAND, NOR, and Hard Disk Drive (HDD). In the following description, the memory device 250 is described as a non-volatile memory (NVM) for simplification and exemplary purposes.

The host 202 can include a host memory (e.g., DRAM). According to an embodiment, the data processing device 200 may include a plurality of storage devices, such as the memory system 210. For example, the data processing device 200 may include a plurality of memory systems 210 configured as a redundant array of independent disks (RAID) that function together as mass storage devices for the host 202. Also, according to an embodiment, the data processing device 200 can include a plurality of computing devices, such as the host 202. For example, the data processing device 200 can include the memory system 210 configured as a shared memory device that the plurality of computing devices, such as the host 202, can use for data storage and retrieval.

The data processing device 200 can include the host 202 that is capable of storing and/or retrieving data in one or more storage devices (e.g., the memory system 210). As illustrated in FIG. 2, the host 202 may perform data communication with the memory system 210 via a host interface (I/F) 220. The host 202 may include a wide range of devices, including mobility electronics such as automotive, electronic devices such as cell phones or MP3 players, computer servers, network attached storage (NAS) devices, desktop computers, notebook (i.e., laptop) computers, tablet computers, set-top boxes, telephones such as “smart” phones, “smart” pads, televisions, cameras, display devices, digital media players, video game consoles, video streaming devices, and the like.

The memory system 210 may include a controller 230, the memory device 250, and the host interface 220. The controller 230 may include a data input/output (I/O) processing unit 232 and a parity device 240. The parity device 240 may include a parity engine 242, a parity migrator 248, a first (1^{st}) buffer 244, and a second (2^{nd}) buffer 246. Herein, the first buffer 244 and the second buffer 246 may be set or established in different memories. In addition, the first buffer 244 and the second buffer 246 may have different data input/output operation speeds. For example, the first buffer 244 can have a faster data input/output operation speed than the second buffer 246. According to an embodiment, the first buffer 244 can be set or established in a static random-access memory (SRAM), and the second buffer 246 can be set or established in a dynamic random-access memory (DRAM).

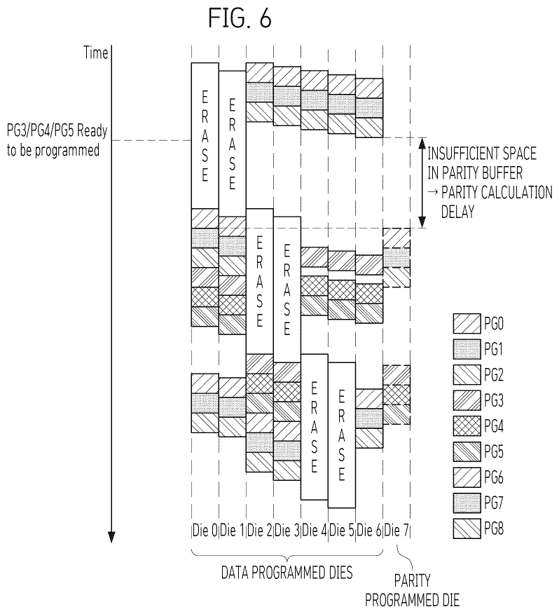

The parity device 240 can be configured to determine usages of the first buffer 244 and the second buffer 246 based on a data input/output operation, an operational state during the execution of the parity generation operation, a data input/output speed, etc. The parity migrator 248 can migrate a parity stored in the first buffer 244 to the second buffer 246 based on a preset condition or an operating state/environment. Through this scheme, the parity device 240 can secure an available space of the first buffer 244 used in a parity calculation for other data. The specific operation and configuration of the parity device 240 will be described hereinafter with reference to FIGS. 6 to 9.

According to an embodiment, the memory system 210 can include additional components not shown in FIG. 2. For example, the memory system 210 can include a printed circuit board (PCB) including electrically conductive wiring, etc., to which components of the memory system 210 are mechanically attached, and electrically interconnecting components of the memory system 210. In some examples, the physical dimensions and connector configurations of the memory system 210 can conform to one or more standard form factors. For example, standard form factors can include, but are not limited to, 2.5-inch data storage devices (e.g., HDD or solid state drive (SSD)), 2.5-inch data storage devices, 1.8-inch data storage devices, peripheral component interconnect (PCI), PCI expansion (PCI-X), PCI Express (PCIe) (e.g., PCIe x1, x4, x8, x16, PCIe Mini Card, MiniPCI, etc.). According to an embodiment, the memory system 210 can be directly connected (e.g., directly soldered) to a motherboard of the host 202.

The host interface 220 of the memory system 210 can include one or both of a data bus for exchanging data with the host 202 and a control bus for exchanging commands with the host 202. The host interface 220 can operate according to any suitable protocol. For example, the host interface 220 can operate according to one or more of advanced technology attachment (ATA) (e.g., serial ATA (SATA) and parallel ATA (PATA)), universal serial bus (USB), multi-media card (MMC), fiber channel protocol (FCP), small computer system interface (SCSI), serial attached SCSI (SAS), serial advanced technology attachment (SATA), mobile industry processor interface (MIPI), PCI, PCIe, NVMe (non-volatile memory express), OpenCAPI, GenZ, Cache Coherent Interface Accelerator (CCIX), Compute Express Link (CXL), open channel solid state drive (Open Channel SSD, OCSSD), or similar protocols. An electrical connection (e.g., a data bus, a control bus, or both) of the host interface 220 can be electrically connected to the controller 230 to provide an electrical connection between the host 202 and the controller 230 to exchange data between the host 202 and the controller 230. According to an embodiment, the electrical connection of the host interface 220 can allow the memory system 210 to receive power from the host 202. For example, a power supply related device of the memory system 210 can receive power from the host 202 via the host interface 220.

The memory system 210 can include a memory device 250 including a plurality of data storage areas. According to an embodiment, the memory device 250 can be configured to store and/or retrieve data. For example, a memory die or memory chip included in the memory device 250 can receive data from the controller 230 and a message or a command instructing the memory device 250 to store the data. Similarly, a memory die or memory chip included in the memory device 250 can receive a message from the controller 230 instructing the memory device 250 to retrieve the data. According to an embodiment, a memory die or memory chip included in the memory device 250 can be configured to store a relatively large amount of data (e.g., 128 MB, 256 MB, 412 MB, 1 GB, 2 GB, 3 GB, 8 GB, 16 GB, 22 GB, 54 GB, 128 GB, 256 GB, 412 GB, 1 TB, etc.).

According to an embodiment, the memory device 250 can include any type of non-volatile memory device, such as a Read Only Memory (ROM), a Mask ROM (MROM), a Programmable ROM (PROM), an Erasable ROM (EPROM), an Electrically Erasable ROM (EEPROM), a Phase change RAM (PRAM), a Magnetic (or magneto-resistive) RAM (MRAM), a NAND or NOR flash memory, a Phase Change Random Access Memory (PCRAM), a Resistive Random Access Memory (RRAM), a Ferroelectric Random Access Memory (FRAM), a Spin Transfer Torque Magnetic Random Access Memory (STT-MRAM), a holographic memory device, a hard disk drive (HDD), and any other type of nonvolatile memory device.

According to an embodiment, the memory device 250 can include a plurality of flash memory devices. The flash memory device can include a NAND or NOR based flash memory device, and can store data based on an amount of charge contained in a floating gate of the transistor for each flash memory cell. In the NAND flash memory device, the flash memory device can be divided into a plurality of blocks, and the blocks can be divided into a plurality of pages. Each block of the plurality of blocks within a particular memory device can include a plurality of NAND cells. Rows of NAND cells can be electrically connected using word lines to establish the plurality of pages. Each cell in each of the plurality of pages can be electrically connected to a respective bit line. Additionally, the NAND flash memory device can be a 2D or 3D device. The flash memory device can include single level cells (SLC), multi-level cells (MLC), triple level cells (TLC), quad level cells (QLC), or higher level cells. The controller 230 can write and read data to and from the NAND flash memory device at the page level, and can erase data stored in the NAND flash memory device at the block level.

A portion of the memory device 250 can be formatted as a logical block, zone, or area such that a storage capacity of the memory device 250 is divided into multiple streams. Each stream can include multiple physical blocks or multiple erase blocks of the memory device 250. Each physical block can be associated with multiple logical blocks. Each logical block can be associated with a unique LBA or sector. Each stream can have a size that is tailored to a storage capacity of one or more physical blocks of the memory device 250. When the controller 230 receives a command such as from the host 202, the controller 230 can read and write data from multiple logical blocks associated with multiple physical blocks of the memory device 250.

The memory system 210 can include a power supply circuit configured to provide power to at least one component. When operating in a standard or normal mode, the power supply circuit can use power provided by an external device, such as the host 202, to power the one or more components. For example, the power supply circuit can power one or more components using power received from the host 202 via the host interface 220. According to an embodiment, the power supply circuit can include one or more power auxiliary devices configured to power one or more components when operating in a shutdown mode, such as when power input from an external device is interrupted. Examples of power auxiliary devices can include, but are not limited to, capacitors, supercapacitors, batteries, etc. According to an embodiment, the amount of power that can be stored by the one or more power storage components can correspond to a function of the cost and/or size (e.g., area/volume) of the one or more power storage components. As the amount of power stored by the one or more power storage components increases, the cost and/or size of the one or more power storage components may also increase.

The memory system 210 can also include a volatile memory device which the controller 230 may use to temporarily store data or information. The volatile memory device can include one or more volatile memories. For example, the controller 230 can use the volatile memory as a cache. The controller 230 can store cached data or information in the volatile memory until the cached data or information is completely written to the memory device 250. Examples of volatile memory can include, but are not limited to, RAM, DRAM, SRAM, and SDRAM (e.g., double data rate 1 (DDR1), DDR2, DDR3, DDR3L, low-power double data rate 3 (LPDDR3), DDR4, LPDDR4, DDR5, LPDDR5, etc.).

Different types of volatile memories can be used with different access properties. For example, DRAM can be arranged for longer burst accesses to allow for improved bandwidth of the same access bus. Alternatively, DRAM can be used with smaller accesses so that random small accesses have better latency. The controller 230 can include additional optional SRAM and/or embedded MRAM. Embedded MRAM is another alternative memory that can be used in other embodiments. Similarly, while access to MRAM may be optimized for various design purposes, the amount of embedded MRAM in the controller 230 could be cost-sensitive. Thus, the choice of how much data and what data goes into premium non-volatile memory and premium volatile memory can be influenced by system tradeoffs.

The controller 230 within the memory system 210 can manage one or more operations of the memory system 210. For example, the data input/output processing unit 232 within the controller 230 can manage or control reading data from and/or writing data to the memory device 250. According to an embodiment, when the memory system 210 receives a write command from the host 202, the controller 230 can start processing a data write command to store data in the memory device 250 and monitor a progress of the data write command. According to an embodiment, the controller 230 can determine at least one operating characteristic of the data processing device 200 and store at least one operating characteristic in the memory device 250.

According to an embodiment, the parity engine 242 in the parity device 240 can be configured to perform logic and/or functions for generating exclusive OR (XOR) parity information. The XOR parity information is a type of parity and is presented for illustrative purposes. According to an embodiment, the parity engine 242 can include circuitry or engines configured to generate a type of parity other than the XOR parity information. The XOR parity information can be used to improve the stability of the memory system 210, for example, to enable data recovery from a failed data write in, or failed data read from, the memory device 250, or to enable data recovery in an event of a power off. The operational reliability of the memory system 210 can be provided based on the XOR parity information generated or calculated based on data stored in the memory system 210. For example, data stored in the memory device 250 through the data input/output processing unit 232 can be written to the memory device 250 through the parity engine 242. The parity engine 242 can store the generated parity information in the first buffer 244, before data and parities are transmitted to the memory device 250.

In addition, the parity device 240 included in the controller 230 can temporarily store data to be written to the memory device 250 or data read from the memory device 250 in the first buffer 244 and the second buffer 246, which are different volatile memories. The first buffer 244 can be used for the parity operation performed by the parity engine 242 in the parity device 240. For example, the first buffer 244 can store a parity generated by the parity engine 242 or a parity used when the parity engine 242 performs a verification operation. According to an embodiment, the first buffer 244 can store a parity group including a plurality of data and a parity stored in, and read from, the memory device 250. If an error occurs while the plurality of data are read from the memory device 250, the parity device 240 may have a capability to recover data corresponding to the error based on the parity group stored in the first buffer 244.

When the parity group is stored and maintained in the first buffer 244 until the memory device 250 stores all of the data and a parity belonging to the parity group, the first buffer 244 may not have sufficient space provided or supported to perform a plurality of data input/output operations. Accordingly, when the parity device 240 needs more space in the first buffer 244 to perform a parity operation on other data (or other parity group), the parity migrator 248 can migrate some of the data and parities stored in the first buffer 244 to the second buffer 246 to secure an available space for the parity operation for the other data. According to an embodiment, each of the first buffer 244 and the second buffer 246 can be configured with at least one of the DRAM and the SRAM.

FIG. 3 illustrates a redundant array of independent (or inexpensive) disks (RAID) applicable to a memory device in accordance with an embodiment of the present disclosure. Specifically, FIG. 3 shows an example of using five regions (Plane1, Plane2, Plane3, Plane4, Plane5) in a Redundant Array of Independent Disks or a Redundant Array of Inexpensive Disks (hereinafter, “RAID”).

Five regions included in the memory device using a RAID scheme can have substantially a same size. According to an embodiment, each of the five regions Plane1, Plane2, Plane3, Plane4, Plane5 included in the memory device 250 can include a memory plane, a memory block, a memory die, or the like. In another embodiment, the five regions Plane1, Plane2, Plane3, Plane4, and Plane5 can be five logical regions established by a user.

In FIG. 3, the memory system 210 can use the RAID scheme to store 4 entries of data A1, A2, A3, A4 and 1 parity Ap in five regions Plane1, Plane2, Plane3, Plane4, Plane5. Even if an error occurs in one region of the five regions Plane1, Plane2, Plane3, Plane4, Plane5, data stored in a region with errors can be recovered and restored based on the other entries of data and the parity stored in the remaining four regions. For example, the parity Ap can be generated by an exclusive-OR (XOR) logical operation on the four entries of data A1, A2, A3, A4. Thereafter, when an error occurs in a second entry of data A2 among the four entries of data A1, A2, A3, A4, the second data A2 can be recovered and restored by an exclusive-OR (XOR) operation on first, third, and fourth entries of data A1, A3, A4 and the entry of parity Ap.

In addition, because it is difficult to predict, from among the five regions Plane1, Plane2, Plane3, Plane4, Plane5, a region in which a problem will occur, locations for storing four entries of data and one entry of parity can be changed. For example, one entry of first parity Ap corresponding to the four entries of first data A1, A2, A3, A4 can be stored in a fifth region Plane5, but one entry of second parity Bp corresponding to four entries of second data B1, B2, B3, B4 can be stored in a fourth region Plane4.

For generating a parity, the memory system 210 can include the parity device 240 shown in FIG. 2. Referring to FIG. 3, in the five regions Plane1, Plane2, Plane3, Plane4, Plane5 of the memory device 250, four entries of first data A1, A2, A3, A4 and one entry of first parity Ap can be programmed. The parity engine 242 may generate one entry of first parity Ap based on the four entries of first data A1, A2, A3, A4. In the memory system 210, four entries of first data A1, A2, A3, A4 can be stored in a first non-volatile cell region, and one entry of first parity Ap can be stored in a second non-volatile cell region. In order to program the multi-bit data, when the memory device 250 according to an embodiment of the disclosure performs a two-step program operation, a parity may be generated and stored in the RAID scheme, and the size of the SLC buffer described above can be reduced or used efficiently.

Referring to FIG. 3, four entries of data A1, A2, A3, and A4 may be used to generate one entry of parity information Ap. In order for the memory system 210 to generate one entry of parity information Ap, it must have a buffer for storing four entries of data A1, A2, A3, and A4 and one entry of parity information Ap. If the memory system 210 generates one parity based on 63 entries of data, the memory system 210 should include a buffer for storing 64 entries of data and parity.

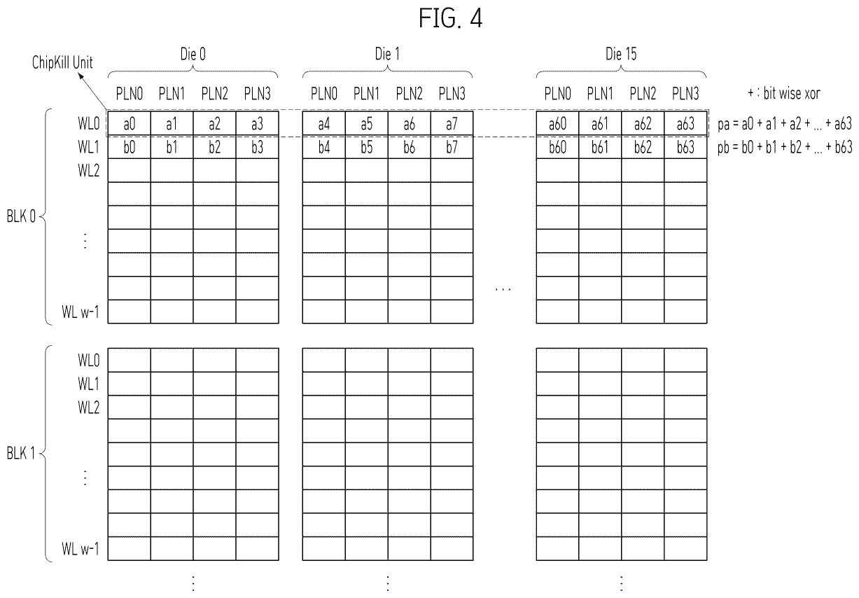

FIG. 4 illustrates an embodiment of storing data in a unit of super memory blocks set within a memory device in accordance with an embodiment of the present disclosure. Specifically, FIG. 4 shows plural memory dies included the memory device 250 shown in FIG. 2. The plural memory dies are capable of storing plural data entries distributed over plural open memory blocks and a parity entry associated with the plural data entries. Herein, the plural open memory blocks can be understood as a super memory block.

Referring to FIG. 4, the memory device 250 can include a plurality of memory dies Die0, Die1, . . . , Die15. Each memory die Die0 to Die15 can include four memory planes PLN0, PLN1, PLN2, PLN3. Each of the memory planes PLN0, PLN1, PLN2, PLN3 can include a plurality of memory blocks BLK0, BLK1, . . . , and each of the memory blocks BLK0, BLK1, . . . can include a plurality of memory cells connected to a plurality of word lines WL0, WL1, WL2, . . . , WLw−1.

According to an embodiment, a non-volatile memory cell of the memory device 250 can store multi-bit data. However, for convenience of description, FIG. 4 shows, as a non-limiting example, the memory device 250 for storing plural data entries a0, a1, a2, . . . , a61, a62 or a63 in plural memory cells coupled to each word line in each memory region or area. The memory system 210 may generate a parity entry pa via a bit wise XOR operation. For example, the parity entry pa can be calculated based on the plural data entries (e.g., pa=a0+a1+ . . . +a63).

In order to improve the speed of the data input/output operation performed in the memory system 210 shown in FIG. 2, the memory system 210 can read or program plural data entries having a preset size together or in parallel. The speed of the data input/output operation can be improved through an interleaving mode in which plural data entries of a preset size are read or programmed in parallel in plural memory areas or regions in which the data input/output operation can be performed independently or individually. In FIG. 4, data input/output operations can be independently or individually performed in each of the memory planes PLN0, PLN1, PLN2, PLN3. For example, open memory block BLK0 included in each of the plural memory planes PLN0, PLN1, PLN2, PLN3 can be included in a super memory block to be programmed with plural data entries transferred from the controller 230.

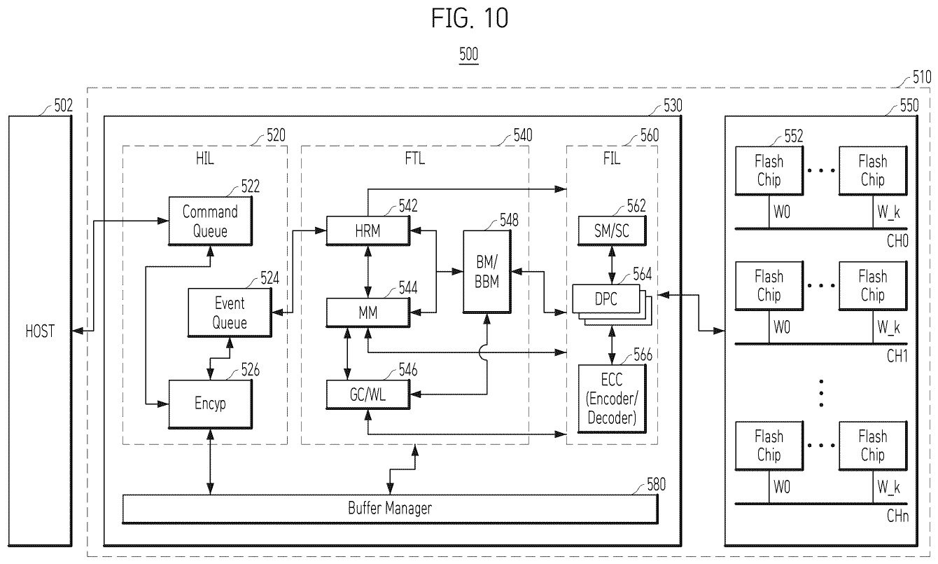

Referring to FIGS. 1 to 4, the memory system 210 can program 64 first data entries a0, a1, a2, . . . , a61, a62, a63 into a memory block included in 64 memory areas or regions (e.g., memory planes). In addition, the memory system 210 can calculate and generate a first parity entry pa based on the 64 first data entries a0, a1, a2, . . . , a61, a62, a63 and program the first parity entry pa in a memory area or regions other than the 64 memory areas or regions. The memory system 210 may distribute and store the 64 first data entries a0, a1, a2, . . . , a61, a62, a63 in 64 memory areas or regions. The first parity entry pa can be stored in another area or region. Herein, the 64 first data entries a0, a1, a2, . . . , a61, a62, a63 and the first parity entry pa could be included in a single chipkill unit or a single chipkill decoding unit. Even if an uncorrectable error correction code (UECC) occurs in one of the data entries or the parity entry included in one chipkill unit, a UECC-generated data entry may be restored based on other data entries and a parity entry having no errors. According to an embodiment, an Error Correction Code (ECC) unit 566 described in FIG. 10 can generate parity information corresponding to a plurality of data or recover the UECC-generated data entry based on the chipkill unit.

Similarly to the first data entries, the memory system 210 can program 64 second data entries b0, b1, b2, . . . , b61, b62, b63 into a memory block included in 64 memory areas or regions (e.g., memory planes). In addition, the memory system 210 can calculate and generate a second parity entry pb based on the 64 second data entries b0, b1, b2, . . . , b61, b62, b63 and program the second parity entry pb in a memory area or regions other than the 64 memory areas or regions. The memory system 210 may include additional sets of data entries with corresponding parity entry.

According to an embodiment, the first and second parity entries pa, pb are not stored in the memory device and can no longer be used after the corresponding data group is successfully stored in the memory device. For example, the first and second parity entries pa, pb can be used in a process of verifying that the corresponding data group is normally programmed in the memory device while programming a large amount of data.

Alternatively, according to an embodiment, the parity pa, pb can be stored in another storage device or area in the memory device. The parity pa, pb can be used to recover damaged data when the data is damaged due to a data retention period or an error or defect of the memory device after being stored in the memory device.

The memory system 210 may be configured to store voluminous data. For example, 3-bit data may be stored in each of the nonvolatile memory cells in the memory device 250, and eight strings may constitute one page. Further, data entries and a parity entry (total 16 entries) may be distributed and stored in 16 open memory blocks in the memory device 250. The data entries may be stored in 15 open memory blocks out of 16 open memory blocks, and the parity entry may be stored in another open memory block. The number of non-volatile memory cells commonly connected to one word line of each of the 16 open memory blocks is 8 (the number of strings), and data stored in each nonvolatile memory cell is 3-bit data, so that 384 (=16×8×3 ) bits of data and parity can be programmed in the memory device 250. The memory system 210 should include a buffer or a cache configured to temporarily store 384-bit data and parity so that the controller 230 generates the parity entry based on the data entries during a program operation.

As the number of open memory blocks in the memory device 250 increases, as the number of strings increases, and as the number of bits of data stored in each non-volatile memory cell increases, the memory system 210 should establish or set a larger buffer or cache for generating parity during a program operation. That is, the size of the buffer or the cache increases. Although this method and apparatus for parity generation might include or perform a simple and repetitive operation, the size of the buffer used for parity generation could increase as the number of data entries stored in the memory device 250 increases. The increased size of the buffer might place a burden on the internal resources of the memory system 210. For example, as the memory system 210 includes a larger buffer for parity generation, a production cost of the memory system 110 may also increase to secure or guarantee I/O throughput.

According to an embodiment, the size of a buffer in which the memory system 210 should secure an available space to generate a parity can be determined in response to a data size of the program operation and a size of the chip kill unit. However, the parity device 240 described in FIG. 2 can try to reduce a size of a buffer used for generating a parity and verifying plural data using a parity due to limitations. The operations of the parity device 240 will be described hereinafter with reference to FIGS. 6 to 9.

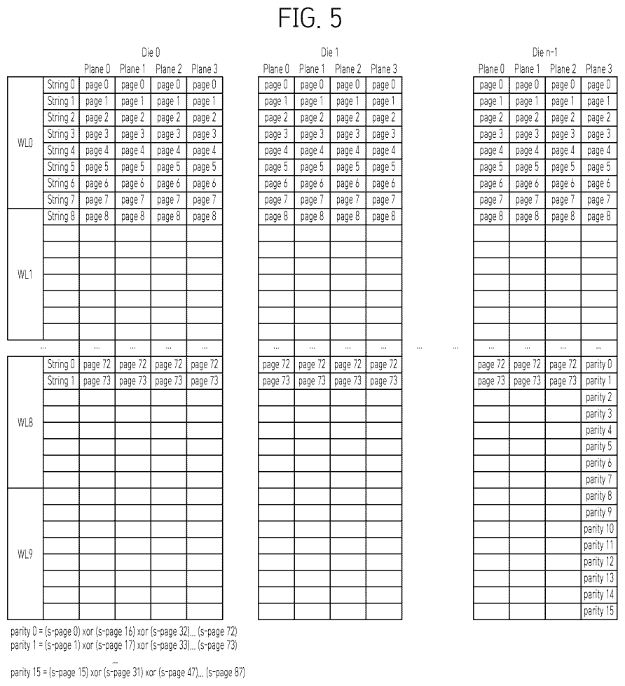

FIG. 5 illustrates an embodiment of a memory device in which multiple write data and parity data are distributed and stored in multiple locations. Specifically, FIG. 5 shows locations where data entries are stored in memory dies Die0, Die1, Die n−1 having a structure in which eight strings String0 to String7 are coupled to each word line WL0, WL1, WL, . . . , WL9. FIG. 5 describes the parity entry generated based on the data entries. In FIG. 5, the data entries and the parity entry can be stored in plural locations of the memory dies Die0, Die1, Die n−1, which are determined in a preset distributed manner.

Referring to FIGS. 1 to 5, the memory device 250 can include plural memory dies Die0, Die1, Die n−1. Each of the memory dies Die0, Die1, Die n−1 can include four memory planes Plane0, Plane1, Plane2, Plane3. Each word line WL0, WL1, WL, . . . , WL9 can be coupled to 8 cell strings String0 to String7. Although FIG. 5 shows an example of the memory device 250 including 10 word lines WL0, WL1, WL, . . . , WL9, the number of word lines included in the memory device 250 can vary based on storage capacity of the memory device 250. A plurality of parities Parity0, Parity1, . . . , Parity15 can be generated for plural data entries which are stored at different locations in the memory device 250. The plurality of parities Parity0, Parity1, . . . , Parity15 can be stored at preset locations. For example, each parity location can specify plural data locations in which data entries corresponding to a parity entry are stored.

Regarding parity generation and storage, a method shown in FIG. 5 might be similar to that shown in FIG. 4. First, based on locations of data entries stored in the memory device 250, combinations of data entries for generating each parity Parity0, Parity1, . . . , Parity15 can be determined. For example, an exclusive OR (XOR) operation on a plurality of data entries s-page0, s-page16, s-page32, s-page72 stored in locations corresponding to a first string String0 coupled to the odd word lines WL0, . . . , WL8 of each plane included in the n number of memory dies can be performed to calculate a first parity parity0. The first parity parity0 may be stored in the first string String0 connected to the ninth word line WL8 in the fourth memory plane Plane3 of the n-th memory die. The other 15 parities parity1, . . . , parity15 can also be generated in the same way and stored in corresponding locations within the memory device 250.

Referring to FIG. 5, the 16 parities parity0, parity1, . . . , parity15 can be generated. The combination of data entries for generating each parity can be called a parity group. The 16 parity groups can be stored in locations corresponding to 10 word lines in the memory device 250. Each parity group can correspond to 16 super-pages. Here, the super page may be a means for managing multiple locations distributed within the memory device 250 as one logical page, such as a super memory group. Provided that the memory device 250 contains 100 word lines, 160 (=16×10) parity groups can be generated and stored. As the number of memory dies in the memory device 250 increases (the larger the value of n), the size of data entries included in each super page increases. Also, the number of data entries included in each parity group may increase. As a result, the amount of parities (or a ratio of parities and data entries) stored in the memory device 250 could be reduced, so that greater number of data entries can be stored even when the storage capacity of the memory device 250 is the same.

According to an internal configuration of the memory device 250 or a set of the parity group, the number of parities stored in the memory device 250 can vary. This may result in a difference in error recovery performance for recovering a data entry in response to an error (e.g., UECC) when the error occurs in the memory device 250.

According to an embodiment, the parity device 240 described in FIG. 2 may require a buffer for storing all data stored in n memory dies (e.g., Die 0, Die 1, . . . , Die n−1) and the generated parity during the generation of parities (e.g., parity 0, parity 1, . . . , parity 15). The size of the buffer used by the parity device 240 might become very large. If a significant amount of the limited internal resources of the memory system 210 are used by the parity device 240, the data input/output performance of the memory system 210 might deteriorate. To reduce the size of the first buffer 244, the parity device 240 could perform an operation for parity generation according to an order in which data is stored in the memory device 250 or use the second buffer 246 to secure an available space in the first buffer 244.

FIG. 6 illustrates a case in which there is no parity migration of a memory system according to an embodiment of the present disclosure. Specifically, FIG. 6 describes an operation performed within the memory system 210 when the parity device 240 described in FIG. 2 does not use the second buffer 246.

Referring to FIG. 2 and FIG. 6, the memory device 250 can include a plurality of memory dies (e.g., Die0 to Die7). For example, among the plurality of memory dies (e.g., Die0 to Die7), plural data can be distributed and stored in seven memory dies (e.g., Die0 to Die6), and a parity can be stored in another memory die (e.g., Die7). Each of the parity groups (e.g., PG0 to PG8) including a plurality of data and parities can include seven data and a parity corresponding to the seven data. According to an embodiment, the memory system 210 can program the parity corresponding to the seven data in a parity memory die (e.g., Die7) after the seven data has been programmed in the seven memory dies (e.g., Die0 to Die6) in the memory device 250.

The memory device 250 can perform operations such as garbage collection, wear leveling, and read reclaim. The memory device 250 can perform an erase operation on a memory block having no valid data. An erase operation ERASE can be performed on at least some of the memory dies among the plurality of memory dies (e.g., Die0 to Die7) in the memory device 250. In the memory device 250, the operational margin of the read operation is shorter than the operational margin of the program operation (or write operation), and the operational margin of the program operation is shorter than the operational margin of the erase operation. When performing a program operation for a parity group (e.g., PG0 to PG8), each including 7 data entries and a parity corresponding to the 7 data entries, timings at which the program operation is performed can be different based on an operating state of each memory die (e.g., Die0 to Die7).

Referring to FIG. 6, a plurality of data and a parity included in a first parity group PG0 can be programmed to each of a plurality of memory dies (e.g., Die0 to Die7). However, an erase operation can be sequentially performed on the first memory die Die0 and the second memory die Die1 among the plurality of memory dies (e.g., Die0 to Die7). Data belonging to the first parity group PG0 can be programmed to each of the third to seventh memory dies (e.g., Die2 to Die6) other than the first memory die Die0 and the second memory die Die1. The first memory die Die0 and the second memory die Die1 could be programmed with data belonging to the first parity group PG0 after the erase operation is performed therein. The parity belonging to the first parity group PG0 can be programmed to the eighth memory die Die7, which is the parity memory die, later than the plurality of data (e.g., the 7 data entries).

A plurality of data and parities belonging to the second parity group PG1 and the third parity group PG2 could also be sequentially programmed in a manner similar to the first parity group PG0. After the parity operation is completed through the parity device 240 described in FIG. 2 for the first to third parity groups PG0 to PG2, the plurality of data and the parities belonging to the first to third parity groups PG0 to PG2 can be sequentially stored. Before the plurality of data and the parity belonging to each of the first to third parity groups PG0 to PG2 are all programmed into the memory device 250, the data and parity belonging to each of the first to third parity groups PG0 to PG2 can be stored in the first buffer 244. However, if the first buffer 244 included in the parity device 240 does not have sufficient storage space, the parity device 240 can have a difficulty performing parity operations on a plurality of data belonging to anther fourth parity group PG3 until the plurality of data and the parity belonging to each of the first to third parity groups PG0 to PG2 are released or erased from the first buffer 244.

Even if plural data belonging to the 4th to 6th parity groups (e.g., PG3 to PG5) are determined, the parity device 240 might not perform parity operations for the 4th to 6th parity groups (e.g., PG3 to PG5) due to a lack of available space (e.g., out of space) in the first buffer 244, so that a program operation for the plural data belonging to the 4th to 6th parity groups (e.g., PG3 to PG5) might not be able to (e.g., could not) be performed. Accordingly, a program operation for data belonging to another parity group (e.g., PG3, etc.) might not be able to (e.g., could not) be performed in the 3rd to 7th memory dies (e.g., Die2 to Die6), even if the program operations for data belonging to each of the 1st to 3rd parity groups (e.g., PG0 to PG2) are completed.

Data belonging to the 1st parity group PG0 are programmed to the 1st memory die Die0 and the 2nd memory die Die1, and parity belonging to the 1st parity group PG0 is programmed to the 8th memory die Die7 which is the parity memory die. Afterwards, the plural data and the parity belonging to the first parity group PG0 stored in the first buffer 244 belonging to the parity device 240 can be released or erased. When an available space is secured in the first buffer 244, the parity device 240 can perform a parity calculation for plural data belonging to another parity group (e.g., PG3, etc.).

As described in FIG. 6, if a space of the parity buffer belonging to the parity device 240 is insufficient, the overall performance of the program operation performed by the memory system 210 could be degraded. According to an embodiment, the number of plural memory dies included in the memory system 250 may vary, and the number of data entries and the number of parities belonging to a single parity group can vary. As described in FIG. 5, the number of data entries belonging to a single parity group can be several tens. As the number of data entries included in a single parity group increases, the amount of data entries stored in the first buffer 244 in the parity device 240 can increase. If there is not sufficient space in the volatile memory in the memory system 250 where the first buffer 244 is set, the number of parity groups in which the parity device 240 can perform parity operations might be limited.

As described in FIG. 6, the erase operation might be performed on at least some memory dies (e.g., Die0 to Die5). Due to this erase operation, data input/output operations (e.g., program operations and read operations) performed in parallel on the plurality of memory dies (e.g., Die0 to Die7) could be performed with delay. When a parity is generated during the program operation or an error is checked or recovered based on a parity during a read operation, the parity device 240 could require a greater size of the first buffer 244. However, the configuration of the memory system 210 might not be able to be easily changed. In particular, if the first buffer 244 is set or established in the SRAM, the size of the SRAM might be difficult to change after manufacturing. Accordingly, the parity device 240 within the memory system 210 can include or establish the second buffer 246 described in FIG. 2.

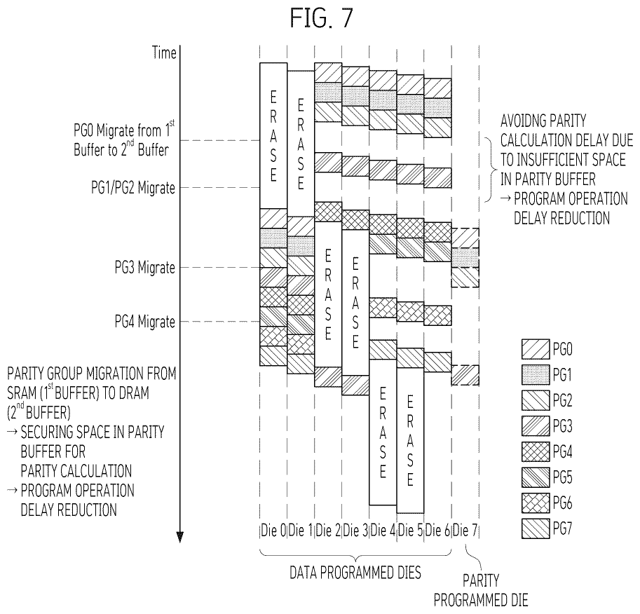

FIG. 7 illustrates a case in which there is parity migration of a memory system according to an embodiment of the present disclosure. Specifically, FIG. 7 describes an operation performed in the memory system 210 when the parity device 240 described in FIG. 2 uses, or operates with, the first buffer 244 and the second buffer 246.

Referring to FIG. 2 and FIG. 7, the memory device 250 can include a plurality of memory dies (e.g., Die0 to Die7). For example, among the plurality of memory dies (e.g., Die0 to Die7), data can be stored in seven memory dies (e.g., Die0 to Die7) while a parity can be stored in another memory die (e.g., Die8). Each of the parity groups (e.g., PG0 to PG7) including a plurality of data and parities can include seven data and a parity associated with the seven data. According to an embodiment, the memory system 210 can program the parity corresponding to the seven data in the parity memory die (e.g., Die8) after seven data are programmed in the seven memory dies (e.g., Die0 to Die7) in the memory device 250.

The memory device 250 can perform operations such as garbage collection, wear leveling, and read reclaim. The memory device 250 can perform an erase operation on a memory block storing no valid data. The erase operation ERASE can be performed on some of the memory dies among the plurality of memory dies (e.g., Die0 to Die7) in the memory device 250. In the memory device 250, a margin of the read operation (i.e., an operational margin) is shorter than a margin of the program operation (or the write operation). Further, a margin of the program operation is shorter than a margin of the erase operation. Program operations for a parity group (e.g., PG0 to PG7), each including 7 data and a parity corresponding to the 7 data, can be individually performed in each memory die (e.g., Die0 to Die7). Timings at which the program operations are performed could be different depending on an operating state of each memory die (e.g., Die0 to Die7).

Referring to FIG. 7, a plurality of data entries and a parity entry included in a first parity group PG0 can be programmed to each of the plurality of memory dies (e.g., Die0 to Die7). However, an erase operation can be sequentially performed on a first memory die Die0 and a second memory die Die1 among the plurality of memory dies (e.g., Die0 to Die7). Data entries belonging to the first parity group PG0 may be programmed to each of the third to seventh memory dies (e.g., Die2 to Die6) other than the first memory die Die0 and the second memory die Die1. The first memory die Die0 and the second memory die Die1 can be programmed with data entries belonging to the first parity group PG0 after the erase operation is performed. The parity entry belonging to the first parity group PG0 can be programmed to the eighth memory die Die7, which is a parity memory die, later than the plurality of data entries programmed in the first to seventh memory dies (e.g., Die0 to Die6).

A plurality of data entries and parity entries belonging to the second parity group PG1 and the third parity group PG2 can also be sequentially programmed in a manner similar to the first parity group PG0. After the parity operation is completed through the parity device 240 described in FIG. 2 for the first to third parity groups (e.g., PG0 to PG2), the data entries and parity entries belonging to the first to third parity groups (e.g., PG0 to PG2) could be sequentially transferred to and stored in the memory device 250. Until the data entries and the parity entry belonging to each of the first to third parity groups (e.g., PG0 to PG2) are all programmed into the memory device 250, the data entries and the parity entry belonging to each of the first to third parity groups (e.g., PG0 to PG2) could be stored and maintained in the first buffer 244.

Because the first buffer 244 included in the parity device 240 might not have sufficient storage space, it could become difficult to perform parity operations on a plurality of data belonging to a new fourth parity group PG3. In this case, the parity migrator 248 in the parity device 240 can move some of the data or parity stored in the first buffer 244 to the second buffer 246. For example, the parity migrator 248 can migrate the data and parity belonging to the first parity group PG0 from the first buffer 244 to the second buffer 246. Through data migration, an available space (e.g., a blank or empty space) could be secured in the first buffer 244, so that the parity device 240 can perform a parity operation for the fourth parity group PG3.

Referring to FIG. 7, after the parity device 240 performs the parity operation on the fourth parity group PG3, at least some of the data belonging to the fourth parity group PG3 could be transferred to, and programmed in, the memory device 250. For example, because the third to seventh memory dies (e.g., Die2 to Die6) are in an idle state after the data belonging to the third parity group PG2 are programmed, the data belonging to the fourth parity group PG3 could be transferred to and programmed in the third to seventh memory dies (e.g., Die2 to Die6).

In addition, the parity migrator 248 in the parity device 240 can migrate data and parities belonging to the second parity group PG1 and the third parity group PG2 stored in the first buffer 244 to the second buffer 246. An available space could be secured in the first buffer 244, so that the parity device 240 can perform parity operations on the fifth parity group PG4 and the sixth parity group PG5. After the parity operations on the fifth parity group PG4 and the sixth parity group PG5 are performed, at least some of data belonging to the fifth parity group PG4 and the sixth parity group PG5 could be transferred in response to the operating states of the plurality of memory dies (e.g., Die0 to Die7).

FIG. 7 illustrates that data belonging to the fifth parity group PG4 and the sixth parity group PG5 are programmed in the fifth to seventh memory dies (e.g., Die4 to Die6). Data belonging to the first to sixth parity groups (e.g., PG0 to PG5) can be sequentially transferred to the first to fourth memory dies (e.g., Die0 to Die3) before or after the erase operation ERASE is performed, so that the data transferred to each memory die could be independently and individually programmed. After data belonging to each of the first to sixth parity groups (e.g., PG0 to PG 5) is stored in the first to seventh memory dies (e.g., Die0 to Die6), parities belonging to each of the first to sixth parity groups (e.g., PG0 to PG 5) can be stored in the eighth memory die Die7.

After data and parities belonging to each of the first to sixth parity groups (e.g., PG0 to PG 5) are programmed to the plurality of memory dies (e.g., Die0 to Die7), each of the first to sixth parity groups (e.g., PG0 to PG 5) migrated from the first buffer 244 to the second buffer 246 by the parity migrator 248 could be released or erased. The parity migrator 248 can migrate at least one parity group stored in the first buffer 244 to the second buffer 246 based on the operating state of the first buffer 244 and the operating states of the plurality of memory dies (e.g., Die0 to Die7) in the memory device 250. Meanwhile, according to an embodiment, the size of the second buffer 246 established in the DRAM can be greater than the size of the first buffer 244 set in the SRAM because the size of the DRAM is greater than that of the SRAM included in the memory system 210 so that an allowable space that can be used as the second buffer 246 in the DRAM could be relatively greater than that of the SRAM.

As described in FIGS. 6 and 7, the second buffer 246 included in the parity device 240 can be used to prevent or avoid the overall performance of the program operation performed by the memory system 210 from being degraded due to insufficient storage space of the first buffer 244. Meanwhile, the parity device 240 does not always migrate the data and parities stored in the first buffer 244 to the second buffer 246. When all of the multiple memory dies (e.g., Die0 to Die7) in the memory device 250 are not in an idle state but in a busy state, other data might not be transferred to the memory device 250 even if the parity device 240 performs a parity operation on the other data. In this case, the overall data input/output operation performance of the memory system 210 might not be improved, so that the parity device 240 migrating the other data from the first buffer 244 to the second buffer 246 could result in unnecessary power waste. Therefore, in an embodiment of the present disclosure, only when at least one of the plurality of memory dies (e.g., Die0 to Die7) in the memory device 250 is in an idle state, the parity device 240 can use the second buffer 248 to secure an available space in the first buffer 244.

Further, with regard to FIGS. 6 and 7, the controller 230 can be configured to secure an available space in the first buffer 244 by migrating a first parity group PG0 associated with a plurality of first data entries from the first buffer 244 to the second buffer 246. When at least one of the plurality of memory planes Plane0, Plane1, Plane2, Plane3 or the plurality of memory dies is in an idle state, at least some of the first parity group PG0 might not be transferred to at least some of the plurality of memory planes Plane0, Plane1, Plane2, Plane3 or the plurality of memory dies. However, because the controller 230 can migrate the first parity group PG0 to secure an available space for another parity group, the controller 230 can perform a parity operation for a second parity group PG1 associated with a plurality of second data entries to be transferred and stored in the memory plane or the memory die that is in the idle state.

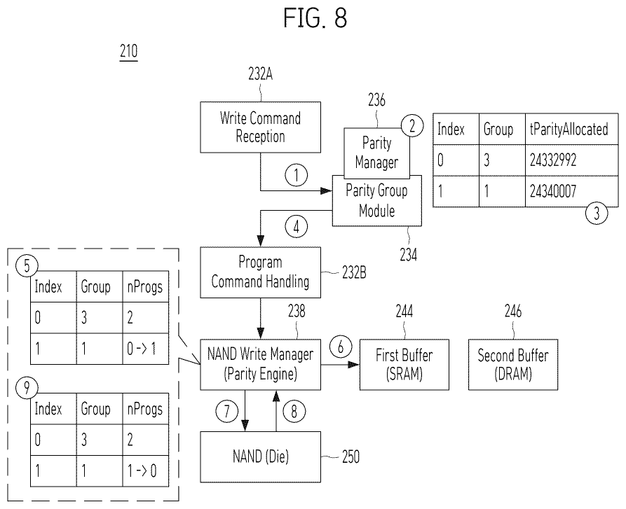

FIG. 8 illustrates a first operation of a memory system according to an embodiment of the present disclosure. Specifically, FIG. 8 describes an operation method for storing point-in-time information regarding a parity generated during a program operation performed based on a write command input to the memory system 210.

Referring to FIG. 2 and FIG. 8, the memory system 210 can include the host interface 220 and the controller 230. The memory system 210 can receive a write command transmitted from an external device (operation 232A). The data input/output processing unit 232 in the controller 230 can perform an internal operation based on the write command. The data input/output processing unit 232 can transmit a task, generated based on the write command transmitted from the host interface 220, to a parity group module 234 (\textcircled{1}).

The data input/output processing unit 232 including the parity group module 234 can determine a parity group by grouping a plurality of write data transmitted together with at least one write command into preset units. The data input/output processing unit 232 can manage the program operation for the parity group set by the parity group module 234. At this time, a parity manager 236 included in the data input/output processing unit 232 can assign an identifier (e.g., ID, Index) to the parity group module 234 by considering a location where the write data is stored in the memory device 250 (\textcircled{2}). The parity manager 236 can allocate the first buffer 244 set or established in the SRAM for the parity group to which the identifier is assigned.

According to an embodiment, the parity group module 234 and the parity manager 236 can use a timer to record a time point (e.g., tParityAllocated) at which the identifier (e.g., ID, Index) is assigned to the parity generated corresponding to the plurality of data belonging to the parity group (\textcircled{3}). According to an embodiment, by using a timer to record a specific time point for parity and to check the specific time point later, the parity group module 234 and the parity manager 236 can check the time at which the parity is stored and maintained in the controller 230. Meanwhile, if another write data has the same logical address as data associated with already generated parity or if another write data belongs to a same parity group, the parity group module 234 and the parity manager 236 can initialize the time point (e.g., tParityAllocated) at which the identifier (e.g., ID, Index) is assigned to the corresponding parity.

When the time point for the parity group is determined by the parity group module 234, the time point for the parity group can be transmitted to the data input/output processing unit 232 in the controller 230 (\textcircled{4}). The data input/output processing unit 232 can set, schedule, and process detailed operations corresponding to a write command for a program operation to be performed in a plurality of storage areas (e.g., the plurality of memory dies, etc.) within the memory device 250 (operation 232B).

According to an embodiment, a program operation manager 238 within the controller 230 can increase count information (e.g., nProgs) of the parity group when a program command for a plurality of data and a parity belonging to a parity group is transmitted (\textcircled{5}). The program operation manager 238 can be included in the parity device 240. The count information (e.g., nProgs) of the parity group can be used to manage or control a plurality of program operations performed in the plurality of storage areas or the plurality of memory dies within the memory device 250 for a plurality of data and parities belonging to the corresponding parity group. For example, if the number of data and a parity belonging to the first parity group is 8, each time the controller 230 processes multiple program operations for 8 entries of data and the parity, the program operation manager 238 can sequentially increase the count information (e.g., nProgs) for the first parity group from ‘0’ to ‘8’.

When the program operation manager 238 transmits a program command for each of the multiple data and parity belonging to the parity group to the memory device 250, the count information (e.g., nProgs) for the corresponding parity group could be decreased. For example, if the number of data and the parity belonging to the first parity group is 8, the count information (e.g., nProgs) for the corresponding parity group can be increased up to 8. When one data or one parity belonging to the first parity group is transmitted to the memory device 250 together with the program command, the count information (e.g., nProgs) could be decreased by one. Meanwhile, even if the parity operation for the data belonging to the first parity group is not completed (i.e., even if the count information (e.g., nProgs) of the first parity group is not 8), the program operation manager 238 could transmit a program command for the data already used in the parity operation to the memory device 250. In this case, the count information (e.g., nProgs) of the first parity group can be increased to a value less than 8. If data belonging to the first parity group is transmitted to the memory device 250 together with the program command as soon as the data is used in the parity operation, the count information (e.g., nProgs) of the first parity group could be changed within a range of ‘0’ to ‘3’ or ‘0’ to ‘2’.

According to an embodiment, referring to FIGS. 6 and 7, the timings at which the data or parity is programmed in the plurality of storage areas or the plurality of memory dies in the memory device 250 in the controller 230 can be different. The program operation manager 238 can sequentially decrease the count information for the parity group from ‘8’ to ‘0’ when the program completion for the data or parity belonging to the parity group is transmitted from the plurality of storage areas or the plurality of memory dies.

The program operation manager 238 can perform a parity operation based on the information transmitted from the data input/output processing unit 232 and plural data belonging to the parity group. According to an embodiment, the program operation manager 238 can include the parity device 240 described in FIG. 2. The generated parity can be stored in the first buffer 244 set or established in the SRAM (\textcircled{6}).

The program operation manager 238 can transmit the plural data and the parity belonging to the parity group to the memory device 250 (\textcircled{7}). Referring to FIGS. 6 and 7, the timing at which each of the plural data entries and the parity entry is transferred (parity group migration) from the controller 230 to each of the plurality of storage areas or each of the plurality of memory dies in the memory device 250 may be determined based on an operation state of the memory device 250. The timings at which the plural data entries and the parity entry are programmed in the plurality of storage areas or the plurality of memory dies in the memory device 250 can be different.

After the plurality of storage areas or the plurality of memory dies in the memory device 250 program the plurality of data and the parity, the plurality of storage areas or the plurality of memory dies can notify the controller 230 of whether the program is complete (\textcircled{8}). When the program operation for the plurality of data and the parity belonging to a specific parity group is completed, the program operation manager 238 in the controller 230 can decrease the count information (e.g., nProgs) of the corresponding parity group (\textcircled{9}).

According to an embodiment, the program operation manager 238 in the controller 230 can increase the count information (e.g., nProgs) of one of the plurality of parity groups in response to the generated program command whenever the program command generated by the controller 230 is received. In addition, through the count information (e.g., nProgs) of the parity group, the controller 230 can recognize whether there is a new parity group to be programmed in the memory device 250 after the corresponding parity group or the number of new parity groups to be programmed in the memory device 250. As the count information for a plurality of parity groups increases, the controller 230 can recognize that the number of other parity groups to be programmed after the corresponding parity group increases or the number of program operations to be performed in the memory device 250 increases. Through this, it could be recognized whether the number of program operations to be processed or performed in the controller 230 and the memory device 250 in the memory system 210 increases or decreases.

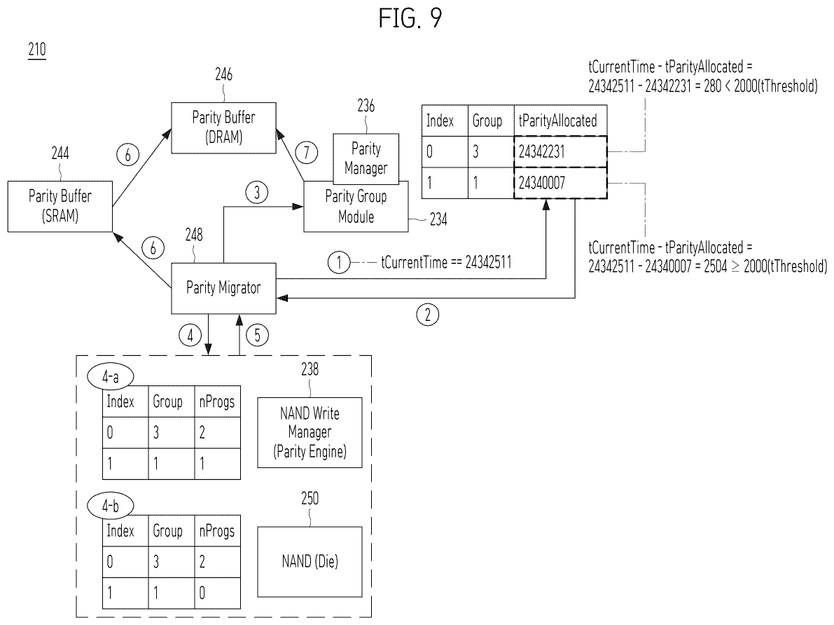

FIG. 9 illustrates a second operation of a memory system according to an embodiment of the present disclosure. Specifically, FIG. 9 describes an operation method for migrating a parity from the first buffer 244 to the second buffer 246 based on time information regarding the parity stored in the memory system 210 described in FIG. 8.

Referring to FIG. 2 and FIG. 9, the parity migrator 248 in the memory system 210 can periodically check a time point (e.g., tParityAllocated) at which an identifier (e.g., ID, Index) is allocated to a parity generated for a program operation performed based on a write command (\textcircled{1}). According to an embodiment, the parity migrator 248 can check the time point (e.g., tParityAllocated) whenever another data or another parity group is ready for a parity calculation.

The parity migrator 248 can determine whether to maintain the corresponding parity in the first buffer 244 or to migrate the corresponding parity to the second buffer 246 based on the time point (e.g., tParityAllocated) at which the identifier is assigned to a specific parity and at least one criterion or threshold value (e.g., 2000) set by the controller 230 (\textcircled{2}). For example, the parity migrator 248 can be configured to determine whether the value obtained by subtracting the time point (e.g., tParityAllocated) stored in the parity from a current time point (e.g., tCurrentTime) is equal to or greater than a reference time (e.g., tThreshold) as in the following Equation 1.

(tCurrentTime−tParityAllocated)≥tThreshold [Equation 1]

The parity migrator 248 can temporarily block the parity group module 234 from assigning the identifier (e.g., ID, Index) to a new parity group based on a comparison result (\textcircled{3}). For example, the parity migrator 248 can change information (e.g., bit value) indicating a processing status for the corresponding parity group so that the parity group module 234 might not assign the identifier (e.g., ID, Index) to the new parity group. If the parity migrator 248 changes the processing status for the parity group, the parity group module 234 might not perform a relevant operation that should be performed to store the corresponding parity group in the memory device 250.

The parity migrator 248 can check the information on the parity group related to the program operation that is performed or to be performed in the memory device 250 through the program operation manager 238 (\textcircled{4}). The parity migrator 248 can check the count information (e.g., nProgs) of the parity group on which the program operation manager 238 performs the parity operation. For example, the count information of the oldest parity group (i.e., the oldest parity group that transmitted the program command to the memory device 250) among the parity groups managed by the program operation manager 238 could be checked. In addition, the parity migrator 248 can check whether all the program commands for the corresponding parity group have been generated and whether the parity operation for the corresponding parity group has been completed based on a check result of the count information (e.g., nProgs) (\textcircled{5}).

According to the embodiment, the parity migrator 248 can determine to move the parity group on which the parity operation has been completed from the first buffer 244 to the second buffer 246. The parity migrator 248 can recognize that the parity operation of the corresponding parity group has been completed by checking that the count information (e.g., nProg) of the corresponding parity group no longer increases.

In addition, according to an embodiment, the parity migrator 248 can copy the parity calculated up to now for the parity group from the first buffer 244 to the second buffer 246 for data backup if the parity operation for a specific parity group is not completed. The parity migrator 248 can recognize that the parity operation for the corresponding parity group is not completed, based on a check result that the count information (e.g., nProg) of the corresponding parity group is increasing.

The parity migrator 248 can determine whether to migrate or copy the corresponding parity group to the second buffer 246 through the count information (e.g., nProg) of the parity group stored in the first buffer 244 (\textcircled{6}). In response to the decision of the parity migrator 248, at least a part of the parity group stored in the first buffer 244 could be migrated or copied to the second buffer 246 (\textcircled{6}).

The parity group module 234 can check the first buffer 244 or the second buffer 246 to determine whether to allocate the identifier (e.g., ID, Index) to perform the parity operation on other data or another parity group (\textcircled{7}). The parity group module 234 can release a temporary blocking of the parity migrator 248 from assigning the identifier (e.g., ID, Index) to the another new parity group. Thereafter, as described in FIG. 8, the parity group module 234 and the parity manager 236 can use the timer to record the time point (e.g. tParityAllocated) at which the identifier (e.g., ID, Index) is allocated to the parity generated corresponding to the plurality of data belonging to the parity group (\textcircled{3} of FIG. 8).

Referring to FIGS. 8 and 9, a plurality of components included in the controller 230 within the memory system 210 can be configured to set a write command and a plurality of data transmitted from an external device into a parity group, to perform a parity operation on data belonging to the corresponding parity group, and to transmit the plural data and the parity belonging to the corresponding parity group after the parity operation to the memory device 250. The controller 230 can generate, control, or manage, during above operations, the identifier (e.g., ID, Index), the time point (e.g., tParityAllocated), and the count information (e.g., nProg) for the corresponding parity group. In addition, the controller 230 can determine whether to migrate or copy the corresponding parity group from the first buffer 244 to the second buffer 246 based on the identifier (e.g., ID, Index), the time point (e.g., tParityAllocated), and the count information (e.g., nProg) for the parity group, thereby enabling more efficient usage of internal resources for the data input/output operations.

FIG. 10 illustrates a data processing system according to an embodiment of the present disclosure.

Referring to FIG. 10, the data processing system 500 may include a host 502 engaged or coupled with a memory system 510. For example, the host 502 and the memory system 510 can be coupled to each other via a data bus, a host cable and the like to perform data communication.

The memory system 510 may include a memory device 550 and a controller 530. The memory device 550 and the controller 530 in the memory system 510 may be considered components or elements physically separated from each other. The memory device 550 and the controller 530 may be connected via at least one data path. For example, the data path may include a channel and/or a way.

The memory device 550 can include plural memory chips (e.g., flash chips) 552 coupled to the controller 530 through plural channels CH0, CH1, . . . , CHn and ways W0, . . . , W_k. The memory chip 552 can include a plurality of memory planes or a plurality of memory dies. According to an embodiment, the memory plane may be considered a logical or a physical partition including at least one memory block, a driving circuit capable of controlling an array including a plurality of non-volatile memory cells, and a buffer that can temporarily store data inputted to, or outputted from, non-volatile memory cells. Each memory plane or each memory die can support an interleaving mode in which plural data input/output operations are performed in parallel or simultaneously. According to an embodiment, memory blocks included in each memory plane, or each memory die, included in the memory device 550 can be grouped as a super memory block to input/output plural data entries. An internal configuration of the memory device 550 shown in FIG. 10 may be changed based on operating performance of the memory system 510. An embodiment of the present disclosure may not be limited to the internal configuration described in FIG. 10.

According to an embodiment, the memory device 550 and the controller 530 may be components or elements functionally divided. Further, according to an embodiment, the memory device 550 and the controller 530 may be implemented with a single chip or a plurality of chips. According to an embodiment, the controller 530 may correspond to the controller 230 shown in FIG. 2

The controller 530 may perform a data input/output operation (such as a read operation, a program operation, an erase operation, etc.) in response to a request or a command input from an external device such as the host 502. For example, when the controller 530 performs a read operation in response to a read request input from an external device, data stored in a plurality of non-volatile memory cells included in the memory device 550 is transferred to the controller 530. Further, the controller 530 can independently perform an operation regardless of the request or the command input from the host 502. Regarding an operating state of the memory device 550, the controller 530 can perform an operation such as garbage collection (GC), wear leveling (WL), a bad block management (BBM) for checking whether a memory block is bad and handling a bad block.

Each memory chip 552 can include a plurality of memory blocks. The memory blocks may be understood to be a group of non-volatile memory cells in which data is removed together by a single erase operation. Although not illustrated, the memory block may include a page which is a group of non-volatile memory cells that store data together during a single program operation or output data together during a single read operation. For example, one memory block may include a plurality of pages. The memory device 550 may include a voltage supply circuit capable of supplying at least one voltage into the memory block. The voltage supply circuit may supply a read voltage, a program voltage, a pass voltage, or an erase voltage into a non-volatile memory cell included in the memory block.

The host 502 interworking with the memory system 510, or the data processing system 500 including the memory system 510 and the host 502, is a mobility electronic device (such as a vehicle), a portable electronic device (such as a mobile phone, an MP3 player, a laptop computer, or the like), and a non-portable electronic device (such as a desktop computer, a game machine, a TV, a projector, or the like). The host 502 may provide interaction between the host 502 and a user using the data processing system 500 or the memory system 510 through at least one operating system (OS). The host 502 may transmit a plurality of commands corresponding to a user's request to the memory system 510, and the memory system 510 may perform data input/output operations corresponding to the plurality of commands (e.g., operations corresponding to the user's request).

Referring to FIG. 10, the controller 530 in the memory system 510 operates along with the host 502 and the memory device 550. As illustrated, the controller 530 may include a layered structure including the host interface layer (HIL) 520, a flash translation layer (FTL) 540, and a flash interface layer (FIL, or a memory interface layer) 560.

The host interface layer (HIL) 520, the flash translation layer (FTL) 540, and the flash interface layer (FIL) 560 described in FIG. 10 are illustrated as one embodiment. The host interface layer (HIL) 520, the flash translation layer (FTL) 540, and the flash interface layer (FIL) 560 may be implemented in various forms according to the operating performance of the memory system 510. According to an embodiment, the host interface layer (HIL) 520, the flash translation layer (FTL) 540, and the flash interface layer (FIL) 560 may perform operations through multi cores or processors having a pipelined structure included in the controller 530.

The host 502 and the memory system 510 may use a predetermined set of rules or procedures for data communication or a preset interface to transmit and receive data therebetween. For example, the host interface layer 520 in the memory system 510 may include a device that can transmit signals, data, etc. to the host 502 or receive signals, data, etc., transmitted from the host 502. According to an embodiment, the host interface layer 520 can be implemented or driven through firmware called a host interface layer (HIL, hereinafter referred to as ‘HIL’) as an area that transmits and receives data with the host 502.

A buffer manager 580 included in the controller 530 can control the input/output of data or operation information in conjunction with the host interface layer (HIL) 520, the flash translation layer (FTL) 540, and the flash interface layer (FIL) 560. To this end, the buffer manager 580 may set or establish various buffers, caches, or queues in a memory, and control data input/output of the buffers, the caches, or the queues, or data transmission between the buffers, the caches, or the queues in response to a request or a command generated by the host interface layer (HIL) 520, the flash translation layer (FTL) 540, and the flash interface layer (FIL) 560. For example, the controller 530 may temporarily store read data provided from the memory device 550 in response to a request from the host 502 before providing the read data to the host 502. Also, the controller 530 may temporarily store write data provided from the host 502 in a memory before storing the write data in the memory device 550. When controlling operations such as a read operation, a program operation, and an erase operation performed within the memory device 550, the read data or the write data transmitted or generated between the controller 530 and the memory device 550 in the memory system 510 could be stored and managed in a buffer, a queue, etc., established in the memory by the buffer manager 580. Besides the read data or the write data, the buffer manager 580 may store signal or information (e.g., map data, a read command, a program command, or etc. which is used for performing operations such as programming and reading data between the host 502 and the memory device 550) in the buffer, the cache, the queue, etc., established in the memory. The buffer manager 580 may set, or manage, a command queue, a program memory, a data memory, a write buffer/cache, a read buffer/cache, a data buffer/cache, a map buffer/cache, and etc. According to an embodiment, the buffer manager 580 can set or establish the first buffer 244 and the second buffer 246 in different volatile memories.

The host interface layer (HIL) 520 may handle commands, data, and the like transmitted from the host 502. By way of example but not limitation, the host interface layer 520 may include a command queue manager 522 and an event queue manager 524. The command queue manager 522 may sequentially store the commands, the data, and the like received from the host 502 in a command queue, and output them to the event queue manager 524, for example, in an order in which they are stored in the command queue manager 522. The event queue manager 524 may sequentially transmit events for processing the commands, the data, and the like received from the command queue. According to an embodiment, the event queue manager 524 may classify, manage, or adjust the commands, the data, and the like received from the command queue. Further, according to an embodiment, the host interface layer 520 can include an encryption manager (Encyp) 526 configured to encrypt a response or output data to be transmitted to the host 502 or to decrypt an encrypted portion in the command or data transmitted from the host 502.

A plurality of commands or data of the same characteristic may be transmitted from the host 502, or a plurality of commands and data of different characteristics may be transmitted to the memory system 510 after being mixed or jumbled by the host 502. For example, a plurality of commands for reading data, i.e., read commands, may be delivered, or commands for reading data, i.e., a read command, and a command for programming/writing data, i.e., a write command, may be alternately transmitted to the memory system 510. The command queue manager 522 of the host interface layer 520 may sequentially store commands, data, and the like, which are transmitted from the host 502, in the command queue. Thereafter, the host interface layer 520 may estimate or predict what type of internal operations the controller 530 will perform according to the characteristics of the commands, the data, and the like, which have been transmitted from the host 502. The host interface layer 520 may determine a processing order and a priority of commands, data and the like based on their characteristics. According to the characteristics of the commands, the data, and the like transmitted from the host 502, the event queue manager 524 in the host interface layer 520 is configured to receive an event, which should be processed or handled internally within the memory system 510 or the controller 530 according to the commands, the data, and the like input from the host 502, from the buffer manager 580. Then, the event queue manager 524 may transfer the event including the commands, the data, and the like into the flash translation layer (FTL) 540.

According to an embodiment, the flash translation layer (FTL) 540 may include a host request manager (HRM) 542, a map manager (MM) 544, a state manager (GL/WL) 546, and a block manager (BM/BBM) 548. Further, according to an embodiment, the flash translation layer (FTL) 540 may implement a multi-thread scheme to perform data input/output (I/O) operations. A multi-thread FTL may be implemented through a multi-core processor using multi-thread included in the controller 530. For example, the host request manager (HRM) 542 may manage the events transmitted from an event queue. The map manager (MM) 544 may handle or control map data. The state manager 546 may perform an operation such as garbage collection (GC) or wear leveling (WL), after checking an operating state of the memory device 550. The block manager 548 may execute commands or instructions onto a block in the memory device 550.

The host request manager (HRM) 542 may use the map manager (MM) 544 and the block manager 548 to handle or process requests according to read and program commands and events which are delivered from the host interface layer 520. The host request manager (HRM) 542 may send an inquiry request to the map manager (MM) 544 to determine a physical address corresponding to a logical address which is entered with the events. The host request manager (HRM) 542 may send a read request with the physical address to the flash interface layer 560 to process the read request, i.e., handle the events. In one embodiment, the host request manager (HRM) 542 may send a program request (or a write request) to the block manager 548 to program data to a specific empty page storing no data in the memory device 550, and then may transmit a map update request corresponding to the program request to the map manager (MM) 544 in order to update an item relevant to the programmed data in information for mapping the logical and physical addresses to each other.

The block manager 548 may convert a program request delivered from the host request manager (HRM) 542, the map manager (MM) 544, and/or the state manager 546 into a flash program request used for the memory device 550, to manage flash blocks in the memory device 550. To maximize or enhance program or write performance of the memory system 510, the block manager 548 may collect program requests and send flash program requests for multiple-plane and one-shot program operations to the flash interface layer 560. In an embodiment, the block manager 548 sends several flash program requests to the flash interface layer 560 to enhance or maximize parallel processing of a multi-channel and multi-directional flash controller.

In an embodiment, the block manager 548 may manage blocks in the memory device 550 according to the number of valid pages, select and erase blocks having no valid pages when a free block is needed and select a block including the least number of valid pages when it is determined that garbage collection is to be performed. The state manager 546 may perform garbage collection to move valid data stored in the selected block to an empty block and erase data stored in the selected block so that the memory device 550 may have enough free blocks (i.e., empty blocks with no data).

When the block manager 548 provides information regarding a block to be erased to the state manager 546, the state manager 546 may check all flash pages of the block to be erased to determine whether each page of the block is valid. For example, to determine validity of each page, the state manager 546 may identify a logical address recorded in an out-of-band (OOB) area of each page. To determine whether each page is valid, the state manager 546 may compare a physical address of the page with a physical address mapped to a logical address obtained from an inquiry request. The state manager 546 may send a program request to the block manager 548 for each valid page. A map table may be updated by the map manager 544 when a program operation is complete.

The map manager 544 may manage map data, e.g., a logical-physical map table. The map manager 544 may process various requests, for example, queries, updates, and the like, which are generated by the host request manager (HRM) 542 or the state manager 546. The map manager 544 may store the entire map table in the memory device 550, e.g., a flash/non-volatile memory, and cache mapping entries according to the storage capacity of the buffer included in, or engaged with, the controller 530. When a map cache miss occurs while processing inquiry or update requests, the map manager 544 may send a read request to the flash interface layer 560 to load a relevant map table stored in the memory device 550. When the number of dirty cache blocks in the map manager 544 exceeds a certain threshold value, a program request may be sent to the block manager 546, so that a clean cache block is made and a dirty map table may be stored in the memory device 550.

When garbage collection is performed, the state manager 546 copies valid page(s) into a free block, and the host request manager (HRM) 542 may program the latest version of the data for the same logical address of the page and concurrently issue an update request. When the state manager 546 requests the map update in a state in which the copying of the valid page(s) is not completed normally, the map manager 544 may not perform the map table update. This is because the map request is issued with old physical information when the state manager 546 requests a map update and a valid page copy is completed later. The map manager 544 may perform a map update operation to ensure accuracy when, or only if, the latest map table still points to the old physical address.

The flash interface layer (FIL) 560 may exchange data, commands, state information, and the like, with a plurality of memory chips 552 in the memory device 550 through a data communication method. According to an embodiment, the flash interface layer 560 may include a status check schedule manager (SM/SC) 562 and a data path manager (DPC) 564. The status check schedule manager 562 can check and determine the operating state regarding the plurality of memory chips 552 coupled to the controller 530, the operating state regarding a plurality of channels CH0, CH1, . . . , CHn and the plurality of ways W0, . . . , W_k, and the like. The transmission and reception of data or commands can be scheduled in response to the operating states regarding the plurality of memory chips 552 and the plurality of channels CH0, CH1, . . . , CHn. The data path manager 564 can control the transmission and reception of data, commands, etc., through the plurality of channels CH0, CH1, . . . , CHn and ways W0, . . . , W_k based on the information transmitted from the status check schedule manager 562. According to an embodiment, the data path manager 564 may include a plurality of transceivers, each transceiver corresponding to each of the plurality of channels CH0, CH1, . . . , CHn. Further, according to an embodiment, the status check schedule manager 562 and the data path manager 564 included in the flash interface layer 560 could be implemented as, or engaged with, a memory control sequence generator (now shown).

According to an embodiment, the flash interface layer 560 may further include an error correction code (ECC) circuitry 566 configured to perform error checking and correction of data transferred between the controller 530 and the memory device 550. The ECC circuitry 566 may be implemented as a separate module, circuit, or firmware in the controller 530, but may also be implemented in each memory chip 552 included in the memory device 550 according to an embodiment. The ECC circuitry 566 may include a program, a circuit, a module, a system, or an apparatus for detecting and correcting an error bit of data processed by the memory device 550.

For finding and correcting any error of data transferred from the memory device 550, the ECC circuitry 566 can include an error correction code (ECC) encoder and an ECC decoder. The ECC encoder may perform error correction encoding of data to be programmed in the memory device 550 to generate encoded data into which a parity bit is added and store the encoded data in the memory device 550. The ECC decoder can detect and correct error bits contained in the data read from the memory device 550 when the controller 530 reads the data stored in the memory device 550. For example, after performing error correction decoding on the data read from the memory device 550, the ECC circuitry 566 can determine whether the error correction decoding has succeeded or not, and outputs an instruction signal, e.g., a correction success signal or a correction fail signal, based on a result of the error correction decoding. The ECC circuitry 566 may use a parity bit, which has been generated during the ECC encoding process for the data stored in the memory device 550, to correct the error bits of the read data entries. When the number of the error bits is greater than or equal to the number of correctable error bits, the ECC circuitry 566 may not correct the error bits and instead may output the correction fail signal indicating failure in correcting the error bits.

According to an embodiment, the ECC circuitry 566 may perform an error correction operation based on a coded modulation such as a low density parity check (LDPC) code, a Bose-Chaudhuri-Hocquenghem (BCH) code, a turbo code, a Reed-Solomon (RS) code, a convolution code, a recursive systematic code (RSC), a trellis-coded modulation (TCM), a Block coded modulation (BCM), or the like. The error correction circuitry 538 may include all circuits, modules, systems, and/or devices for performing the error correction operation based on at least one of the above-described codes.

For example, the encoder in the ECC circuitry 566 may generate a codeword that is an ECC-applied data unit. A codeword of length n bits may include k bits of user data and (n−k) bits of parity. A code rate may be calculated as (k/n). The higher the code rate, the more user data that can be stored in a given codeword. When the length of the codeword is longer and the code rate is smaller, the error correction capability of the ECC circuitry 566 could be improved. In addition, the ECC circuitry 566 performs decoding using information read from the channels CH0, CH1, . . . , CHn. The decoder in the ECC circuitry 566 can be classified into a hard decision decoder and a soft decision decoder according to how many bits represent the information to be decoded. A hard decision decoder performs decoding with a memory cell output information expressed in 1 bit, and the 1-bit information used at this time is called hard decision information. A soft decision decoder uses more accurate memory cell output information composed of 2 bits or more, and this information is called soft decision information. The ECC circuitry 566 may correct errors included in data using the hard decision information or the soft decision information.

According to an embodiment, to increase the error correction capability, the ECC circuitry 566 may use a concatenated code using two or more codes. In addition, the ECC circuitry 566 may use a product code that divides one codeword into several rows and columns and applies a different relatively short ECC to each row and column.

In accordance with an embodiment, a manager included in the host interface layer 520, the flash translation layer (FTL) 540, and the flash interface layer (FIL) 560 could be implemented with a general processor, an accelerator, a dedicated processor, a co-processor, a multi-core processor, or the like. According to an embodiment, the manager can be implemented with firmware working with a processor.

The memory device 550 can correspond to the memory device 250 described in FIG. 2. According to an embodiment, the memory device 550 can include a plurality of memory devices providing the same characteristics and the same size of storage space, or may include a plurality of memories providing different characteristics and different sizes of storage space. In addition, the memory device 550 can include a plurality of storage spaces or areas capable of distributing and storing data. The ECC circuitry 566 can generate parity of data distributed and stored in the plurality of storage spaces or areas, like the parity device 240 shown in FIG. 2.

According to an embodiment, the memory system 510 may support dividing a storage area in which data entries are stored in the memory device 550 based on a preset standard and dedicating each of divided areas to a specific range of logical block addresses (LBA). When supporting zoned namespaces, the memory system 510 can increase access efficiency and reduce an access time by using a logical block address range dedicated for each area rather than using a specific logical block address range that spans multiple areas. For example, zoned namespaces can improve write performance, which can be useful for workloads that require sequential writes of large amounts of data, such as video streaming or data backup.

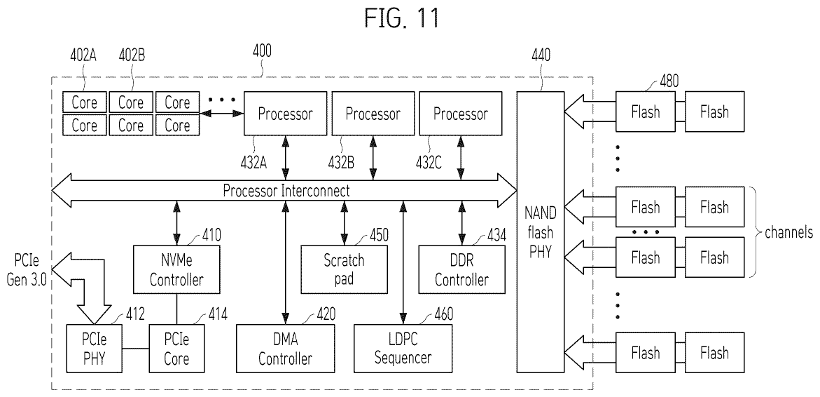

FIG. 11 illustrates a memory system according to an embodiment of the present disclosure. FIG. 11 shows a memory system including multiple cores or multiple processors, which is an example of a data storage system. The memory system may support the Non-Volatile Memory Express (NVMe) protocol.

The NVMe is a type of transfer protocol designed for a solid-state memory that is capable of operating much faster than a conventional hard drive. The NVMe can support higher input/output operations per second (IOPS) and lower latency, resulting in faster data transfer speeds and improved overall performance of the data storage system. Unlike SATA which has been designed for a hard drive, the NVMe can leverage the parallelism of solid-state storage to enable more efficient use of multiple queues and processors (e.g., CPUs). The NVMe is designed to allow hosts to use many threads to achieve higher bandwidth. The NVMe can allow the full level of parallelism offered by SSDs to be fully exploited. However, because of limited firmware scalability, limited computational power, and high hardware contention within SSDs, the memory system may not (be able to) process a large number of I/O requests in parallel.

Referring to FIG. 11, the host, which is an external device, can be coupled to the memory system through a plurality of PCIe Gen 3.0 lanes, a PCIe physical layer (PCIe PHY) 412, and a PCIe core 414. A controller 400 may include three embedded processors 432A, 432B, 432C, each using a plurality of cores 402A, 402B. Herein, the plurality of cores 402A, 402B or the plurality of embedded processors 432A, 432B, 432C may have a pipeline structure.

The plurality of embedded processors 432A, 432B, 432C may be coupled to an internal DRAM controller (DDR controller) 434 through a processor interconnect. The controller 400 further includes a Low Density Parity-Check (LDPC) sequencer 460, a Direct Memory Access (DMA) controller 420, a scratch pad memory 450 for metadata management, and an NVMe controller 410. Components within the controller 400 may be coupled to a plurality of channels connected to a plurality of memory packages (Flash) 480 through a flash physical layer (NAND flash PHY) 440. The plurality of memory packages 480 may correspond to the plurality of memory chips 552 described in FIG. 10.

According to an embodiment, the NVMe controller 410 included in the controller 400 is a type of storage controller designed for use with solid state drives (SSDs) that use an NVMe interface. The NVMe controller 410 may manage data transfer between the SSD and the computer CPU as well as other functions such as error correction, wear leveling, and power management. The NVMe controller 410 may use a simplified, low-overhead protocol to support fast data transfer rates.

According to an embodiment, a scratch pad (memory) 450 may be a storage area set by the NVMe controller 410 to temporarily store data. The scratch pad memory 450 may be used to store data waiting to be written to a plurality of memory packages 480. The scratch pad memory 450 can also be used as a buffer to speed up the writing process, typically with a small amount of Dynamic Random Access Memory (DRAM) or Static Random Access Memory (SRAM). When a write command is executed, data may first be written to the scratch pad memory 450 and then transferred to the plurality of memory packages 480 in larger blocks. The scratch pad memory 450 may be used as a temporary memory buffer to help optimize the write performance of the plurality of memory packages 480. The scratch pad memory 450 may serve as intermediate storage of data before the data is written to non-volatile memory cells.

The Direct Memory Access (DMA) engine (controller) 420 included in the controller 400 is a component that transfers data between the NVMe controller 410 and a host memory in the host system without involving a host's processor. The DMA engine 420 can support the NVMe controller 410 to directly read or write data from or to the host memory without intervention of the host's processor. According to an embodiment, the DMA engine 420 may achieve or support high-speed data transfer between a host and an NVMe device, using a DMA descriptor that includes information regarding data transfer such as a buffer address, a transfer length, and other control information.

The LDPC sequencer 460 in the controller 400 is a component that performs error correction on data stored in the plurality of memory packages 480. Herein, an LDPC code is a type of error correction code commonly used in a NAND flash memory to reduce a bit error rate. The LDPC sequencer 460 may be designed to immediately process encoding and decoding of LDPC codes when reading and writing data from and to the NAND flash memory. According to an embodiment, the LDPC sequencer 460 may divide data into plural blocks, encode each block using an LDPC code, and store the encoded data in the plurality of memory packages 480. Thereafter, when reading the encoded data from the plurality of memory packages 480, the LDPC sequencer 460 can decode the encoded data based on the LDPC code and correct errors that may have occurred during a write or read operation. The LDPC sequencer 460 may correspond to the ECC circuitry 566 described in FIG. 10.

As described above, an embodiment of the present disclosure can provide an apparatus and an operating method for dividing write data input from an external device into preset units to determine a parity group, generating a parity for the corresponding parity group, and migrating the corresponding parity group from a first memory in which a first buffer supporting a fast operation is set to a second memory in which a second buffer supporting a slow operation is set before the plurality of data and the parity are transmitted to and stored in the memory device, thereby securing an available space in the first buffer. Through this scheme, the memory device or the memory system can perform a parity operation to store another data in the memory device, thereby improving the data input/output performance (e.g., throughput) of the memory device or the memory system.

A data storage device, a memory device or a memory system according to an embodiment of the present disclosure can avoid or reducing deterioration of data input/output performance without increasing a size of a memory, a buffer, or a cache that supports fast operation in a procedure of storing a large amount of data, thereby improving the data input/output performance of the memory system.

In addition, a memory device or a memory system according to an embodiment of the present disclosure can improve usage efficiency of internal resources, thereby reducing or avoiding delays in operations of programming plural data by distributing the plural data to multiple storage areas, thereby improving a tail latency without increasing a buffer size of the memory system.

The methods, processes, and/or operations described herein may be performed by code or instructions to be executed by a computer, processor, controller, or other signal processing device. The computer, processor, controller, or other signal processing device may be those described herein or one in addition to the elements described herein. Because the algorithms that form the basis of the methods (or operations of the computer, processor, controller, or other signal processing device) are described in detail, the code or instructions for implementing the operations of the method embodiments, may transform the computer, processor, controller, or other signal processing device into a special-purpose processor for performing the methods herein.

Also, another embodiment may include a computer-readable medium, e.g., a non-transitory computer-readable medium, for storing the code or instructions described above. The computer-readable medium may be a volatile or non-volatile memory or other storage device, which may be removably or fixedly coupled to the computer, processor, controller, or other signal processing device which is to execute the code or instructions for performing the method embodiments or operations of the apparatus embodiments herein.

The controllers, processors, control circuitry, devices, modules, units, multiplexers, logic, interfaces, decoders, drivers, generators and other signal generating and signal processing features of the embodiments disclosed herein may be implemented, for example, in non-transitory logic that may include hardware, software, or both. When implemented at least partially in hardware, the controllers, processors, control circuitry, devices, modules, units, multiplexers, logic, interfaces, decoders, drivers, generators and other signal generating and signal processing features may be, for example, any of a variety of integrated circuits including but not limited to an application-specific integrated circuit, a field-programmable gate array, a combination of logic gates, a system-on-chip, a microprocessor, or another type of processing or control circuit.

When implemented at least partially in software, the controllers, processors, control circuitry, devices, modules, units, multiplexers, logic, interfaces, decoders, drivers, generators and other signal generating and signal processing features may include, for example, a memory or other storage device for storing code or instructions to be executed, for example, by a computer, processor, microprocessor, controller, or other signal processing device. The computer, processor, microprocessor, controller, or other signal processing device may be those described herein or one in addition to the elements described herein. Because the algorithms that form the basis of the methods (or operations of the computer, processor, microprocessor, controller, or other signal processing device) are described in detail, the code or instructions for implementing the operations of the method embodiments, may transform the computer, processor, controller, or other signal processing device into a special-purpose processor for performing the methods described herein.

While the present teachings have been illustrated and described with respect to specific embodiments, it will be apparent to those skilled in the art in light of the present disclosure that various changes and modifications may be made without departing from the spirit and scope of the disclosure as defined in the following claims. Furthermore, the embodiments may be combined to form additional embodiments.

What is claimed is:

1. A memory system, comprising:
a memory device comprising a plurality of data storage areas; and
a controller configured to:
secure an available space in a first parity buffer by migrating a first parity, corresponding to a plurality of first data, from the first parity buffer to a second parity buffer when at least one area among the plurality of data storage areas is in an idle state and a time for which the first parity is stored in the first parity buffer is greater than a reference time;
generate a second parity corresponding to a plurality of second data; and
store the second parity in the available space in the first parity buffer.

2. The memory system according to claim 1, wherein the first parity buffer has a faster data input and output (input/output) speed than the second parity buffer.

3. The memory system according to claim 2, wherein the first parity buffer is set or established in a static random-access memory (SRAM), and the second parity buffer is set or established in a dynamic random-access memory (DRAM).

4. The memory system according to claim 1, wherein the controller is configured to migrate a first parity group, comprising the first parity and the plurality of first data, from the first parity buffer to the second parity buffer.

5. The memory system according to claim 4, wherein the controller is configured to release the first parity group from the second parity buffer based on a program completion for the first parity and the plurality of first data from the memory device.

6. The memory system according to claim 1, wherein the controller is configured to receive a plurality of data from an external device, determine the plurality of first data from the plurality of data, and map a physical address in the memory device where the plurality of first data are stored and a logical address of the plurality of first data.

7. The memory system according to claim 1, wherein each of the plurality of data storage areas in the memory device is configured to independently perform a read operation, a program operation, and an erase operation, and
wherein, while the erase operation is performed in a first storage area among the plurality of data storage areas, the program operation or the read operation is performed in a second storage area among the plurality of data storage areas.

8. The memory system according to claim 7, wherein each of the plurality of data storage areas comprises a memory die or a memory plane.

9. The memory system according to claim 1, wherein the controller is configured to transfer the plurality of first data to the memory device and then transfer the first parity to the memory device, and
wherein the memory system is configured to distribute and program the plurality of first data and the first parity in different data storage areas.

10. The memory system according to claim 1, wherein the controller is configured to:
maintain the first parity in the first parity buffer and delay generation of the second parity when the plurality of data storage areas are busy; and
delay the generation of the second parity when there is no available space for storing the second parity in the first parity buffer.

11. The memory system according to claim 1, wherein the controller is configured to periodically check a time length that the first parity is stored in the first parity buffer; and
wherein the reference time is less than an operation margin of the erase operation performed in the memory device and greater than an operation margin of the program operation.

12. A memory system, comprising:
a memory device comprising a plurality of memory planes or a plurality of memory dies configured to independently perform data input and output (input/output) operations; and
a controller configured to:
migrate a first parity associated with a plurality of first data from a first page buffer to a second page buffer to secure an available space in the first page buffer, the first parity being remained in the first page buffer based on whether the plurality of first data are stored in the plurality of memory planes or the plurality of memory dies after transferring the plurality of first data to the plurality of memory planes or the plurality of memory dies;
generate a second parity associated with a plurality of second data to be transferred and stored in the plurality of memory planes or the plurality of memory dies; and
store the second parity in the available space.

13. The memory system according to claim 12, wherein the controller is configured to migrate the first parity from the first page buffer to the second page buffer when a time for which the first parity has been stored in the first page buffer is greater than a reference time.

14. The memory system according to claim 12, wherein the first parity buffer has a faster data input/output speed than the second parity buffer.

15. The memory system according to claim 12, wherein the controller is configured to migrate a first parity group, comprising the first parity and the plurality of first data, from the first parity buffer to the second parity buffer.

16. The memory system according to claim 15, wherein the controller is configured to release the first parity group from the second parity buffer based on a program completion for the first parity and the plurality of first data from the memory device.

17. The memory system according to claim 12, wherein the controller is configured to:
transmit each of the plurality of first data to the plurality of memory dies or the plurality of memory planes in a distributed manner; and
transmit the first parity to a memory plane or a memory die to which the plurality of first data has not been transmitted.

18. The memory system according to claim 12, wherein the controller is configured to:
maintain the first parity in the first parity buffer and delay the generation of the second parity when all of the plurality of memory planes or the plurality of memory dies are busy; and
delay the generation of the second parity when there is no available space for storing the second parity in the first parity buffer.

19. A method for operating a memory system, comprising:
determining a plurality of first data distributed and stored in a plurality of memory planes or a plurality of memory dies;
calculating a first parity associated with the plurality of first data;
determining whether at least one of the plurality of memory planes or the plurality of memory dies is idle after transferring at least some of the plurality of first data to the plurality of memory planes or the plurality of memory dies;
migrating the first parity from a first page buffer to a second page buffer when the at least one of the plurality of memory planes or the plurality of memory dies is idle to secure an available in the first page buffer; and
generating a second parity which is stored in the available space and associated with the plurality of second data to be distributed and stored in the plurality of memory planes or the plurality of memory dies.

20. The method according to claim 19, further comprising:
transferring the first parity stored in the second parity buffer after the plurality of first data are stored in the plurality of memory planes or the plurality of memory dies.
